(19) United States
(12) Patent Application Publication
(10) Pub. No.: US 2003/0174241 A1
(43) Pub. Date: Sep. 18, 2003

(54) Method of color correcting a sensed image

(76) Inventor: Kia Silverbrook, Balmain (AU)

Correspondence Address: SILVERBROOK RESEARCH PTY LTD, 393 DARLING STREET, BALMAIN, 2041, AU

(21) Appl. No.: 10/309,186

(22) Filed: Dec. 4, 2002

Related U.S. Application Data
(63) Continuation of application No. 09/113,094, filed on Jul. 10, 1998.

(30) Foreign Application Priority Data
Dec. 12, 1997 (AU) PP0876
Jul. 15, 1997 (AU) PO7991

(51) Int. Cl. H04N 5/225; H04N 5/228

(52) U.S. Cl. 348/375; 348/207.2; 348/222.1; 348/374

(57) ABSTRACT

A camera includes an image sensor for sensing an image; a processor for processing the sensed image; and a printing system for printing out the sensed image. The processor provides color correction of a sensed image before being printed out by the printhead comprising the steps of utilizing the image sensor device to sense a first image; processing the first image to determine color characteristics of the first image; utilizing the image sensor device to sense a second image, in rapid succession to the first image; applying color correction to the second image based on the determined color characteristics of the first image; and printing out the second image. Preferably, the second image is sensed within 1 second of the first image and the processing step includes examining the intensity characteristics of the first image. The processing step can also include determining a maximum and minimum intensity of the first image and utilizing the intensities to rescale the intensities of the second image.

Continuation application of U.S. Ser. No. 09/113,094 filed on Jul. 10, 1998

### CROSS REFERENCES TO RELATED APPLICATIONS

The following Australian provisional patent applications are hereby incorporated by cross-reference. For the purposes of location and identification, US patents/patent applications identified by their US patent/patent application serial numbers are listed alongside the Australian applications from which the US patents/patent applications claim the right of priority.

| CROSS-REFERENCED | U.S. PATENT/ | |
|---|---|---|
| AUSTRALIAN | PATENT APPLICATION | |
| PROVISIONAL | (CLAIMING RIGHT OF | |
| PATENT | PRIORITY FROM AUSTRALIAN | DOCKET |
| APPLICATION NO. | PROVISIONAL APPLICATION) | NO. |
| PO7991 | 09/113,060 | ART01 |
| PO8505 | 09/113,070 | ART02 |
| PO7988 | 09/113,073 | ART03 |
| PO9395 | 6,322,181 | ART04 |
| PO8017 | 09/112,747 | ART06 |
| PO8014 | 09/112,776 | ART07 |
| PO8025 | 09/112,750 | ART08 |
| PO8032 | 09/112,746 | ART09 |
| PO7999 | 09/112,743 | ART10 |
| PO7998 | 09/112,742 | ART11 |
| PO8031 | 09/112,741 | ART12 |
| PO8030 | 6,196,541 | ART13 |
| PO7997 | 6,195,150 | ART15 |
| PO7979 | 09/113,053 | ART16 |
| PO8015 | 09/112,738 | ART17 |
| PO7978 | 09/113,067 | ART18 |
| PO7982 | 09/113,063 | ART19 |
| PO7989 | 09/113,069 | ART20 |
| PO8019 | 09/112,744 | ART21 |
| PO7980 | 6,356,715 | ART22 |
| PO8018 | 09/112,777 | ART24 |
| PO7938 | 09/113,224 | ART25 |
| PO8016 | 6,366,693 | ART26 |
| PO8024 | 09/112,805 | ART27 |
| PO7940 | 09/113,072 | ART28 |
| PO7939 | 09/112,785 | ART29 |
| PO8501 | 6,137,500 | ART30 |
| PO8500 | 09/112,796 | ART31 |
| PO7987 | 09/113,071 | ART32 |
| PO8022 | 09/112,824 | ART33 |
| PO8497 | 09/113,090 | ART34 |
| PO8020 | 09/112,823 | ART38 |
| PO8023 | 09/113,222 | ART39 |
| PO8504 | 09/112,786 | ART42 |
| PO8000 | 09/113,051 | ART43 |
| PO7977 | 09/112,782 | ART44 |
| PO7934 | 09/113,056 | ART45 |
| PO7990 | 09/113,059 | ART46 |
| PO8499 | 09/113,091 | ART47 |
| PO8502 | 6,381,361 | ART48 |
| PO7981 | 6,317,192 | ART50 |
| PO7986 | 09/113,057 | ART51 |
| PO7983 | 09/113,054 | ART52 |
| PO8026 | 09/112,752 | ART53 |
| PO8027 | 09/112,759 | ART54 |
| PO8028 | 09/112,757 | ART56 |
| PO9394 | 6,357,135 | ART57 |
| PO9396 | 09/113,107 | ART58 |
| PO9397 | 6,271,931 | ART59 |
| PO9398 | 6,353,772 | ART60 |
| PO9399 | 6,106,147 | ART61 |
| PO9400 | 09/112,790 | ART62 |
| PO9401 | 6,304,291 | ART63 |
| PO9402 | 09/112,788 | ART64 |
| PO9403 | 6,305,770 | ART65 |
| PO9405 | 6,289,262 | ART66 |
| PP0959 | 6,315,200 | ART68 |
| PP1397 | 6,217,165 | ART69 |
| PP2370 | 09/112,781 | DOT01 |
| PP2371 | 09/113,052 | DOT02 |
| PO8003 | 6,350,023 | Fluid01 |
| PO8005 | 6,318,849 | Fluid02 |
| PO9404 | 09/113,101 | Fluid03 |
| PO8066 | 6,227,652 | IJ01 |
| PO8072 | 6,213,588 | IJ02 |
| PO8040 | 6,213,589 | IJ03 |
| PO8071 | 6,231,163 | IJ04 |
| PO8047 | 6,247,795 | IJ05 |
| PO8035 | 6,394,581 | IJ06 |
| PO8044 | 6,244,691 | IJ07 |
| PO8063 | 6,257,704 | IJ08 |
| PO8057 | 6,416,168 | IJ09 |
| PO8056 | 6,220,694 | IJ10 |
| PO8069 | 6,257,705 | IJ11 |
| PO8049 | 6,247,794 | IJ12 |
| PO8036 | 6,234,610 | IJ13 |
| PO8048 | 6,247,793 | IJ14 |
| PO8070 | 6,264,306 | IJ15 |
| PO8067 | 6,241,342 | IJ16 |
| PO8001 | 6,247,792 | IJ17 |
| PO8038 | 6,264,307 | IJ18 |
| PO8033 | 6,254,220 | IJ19 |
| PO8002 | 6,234,611 | IJ20 |
| PO8068 | 6,302,528 | IJ21 |
| PO8062 | 6,283,582 | IJ22 |
| PO8034 | 6,239,821 | IJ23 |
| PO8039 | 6,338,547 | IJ24 |
| PO8041 | 6,247,796 | IJ25 |
| PO8004 | 09/113,122 | IJ26 |
| PO8037 | 6,390,603 | IJ27 |
| PO8043 | 6,362,843 | IJ28 |
| PO8042 | 6,293,653 | IJ29 |
| PO8064 | 6,312,107 | IJ30 |
| PO9389 | 6,227,653 | IJ31 |
| PO9391 | 6,234,609 | IJ32 |
| PP0888 | 6,238,040 | IJ33 |
| PP0891 | 6,188,415 | IJ34 |
| PP0890 | 6,227,654 | IJ35 |
| PP0873 | 6,209,989 | IJ36 |
| PP0993 | 6,247,791 | IJ37 |
| PP0890 | 6,336,710 | IJ38 |
| PP1398 | 6,217,153 | IJ39 |
| PP2592 | 6,416,167 | IJ40 |
| PP2593 | 6,243,113 | IJ41 |
| PP3991 | 6,283,581 | IJ42 |
| PP3987 | 6,247,790 | IJ43 |
| PP3985 | 6,260,953 | IJ44 |
| PP3983 | 6,267,469 | IJ45 |
| PO7935 | 6,224,780 | IJM01 |
| PO7936 | 6,235,212 | IJM02 |
| PO7937 | 6,280,643 | IJM03 |
| PO8061 | 6,284,147 | IJM04 |
| PO8054 | 6,214,244 | IJM05 |
| PO8065 | 6,071,750 | IJM06 |
| PO8055 | 6,267,905 | IJM07 |
| PO8053 | 6,251,298 | IJM08 |
| PO8078 | 6,258,285 | IJM09 |
| PO7933 | 6,225,138 | IJM10 |
| PO7950 | 6,241,904 | IJM11 |
| PO7949 | 09/113,129 | IJM12 |
| PO8060 | 09/113,124 | IJM13 |
| PO8059 | 6,231,773 | IJM14 |
| PO8073 | 6,190,931 | IJM15 |
| PO8076 | 6,248,249 | IJM16 |
| PO8075 | 09/113,120 | IJM17 |
| PO8079 | 6,241,906 | IJM18 |
| PO8050 | 09/113,116 | IJM19 |
| PO8052 | 6,241,905 | IJM20 |
| PO7948 | 09/113,117 | IJM21 |
| PO7951 | 6,231,772 | IJM22 |
| PO8074 | 6,274,056 | IJM23 |
| PO7941 | 09/113,110 | IJM24 |
| PO8077 | 6,248,248 | IJM25 |
| PO8058 | 09/113,087 | IJM26 |
| PO8051 | 09/113,074 | IJM27 |
| PO8045 | 6,110,754 | IJM28 |
| PO7952 | 09/113,088 | IJM29 |
| PO8046 | 09/112,771 | IJM30 |
| PO9390 | 6,264,849 | IJM31 |
| PO9392 | 6,254,793 | IJM32 |
| PP0889 | 6,235,211 | IJM35 |
| PP0887 | 09/112,801 | IJM36 |
| PP0882 | 6,264,850 | IJM37 |
| PP0874 | 6,258,284 | IJM38 |
| PP1396 | 09/113,098 | IJM39 |
| PP3989 | 6,228,668 | IJM40 |
| PP2591 | 6,180,427 | IJM41 |
| PP3990 | 6,171,875 | IJM42 |
| PP3986 | 6,267,904 | IJM43 |
| PP3984 | 6,245,247 | IJM44 |
| PP3982 | 09/112,835 | IJM45 |
| PP0895 | 6,231,148 | IR01 |
| PP0870 | 09/113,106 | IR02 |
| PP0869 | 09/113,105 | IR04 |
| PP0887 | 09/113,104 | IR05 |
| PP0885 | 6,238,033 | IR06 |
| PP0884 | 09/112,766 | IR10 |
| PP0886 | 6,238,111 | IR12 |
| PP0871 | 09/113,086 | IR13 |
| PP0876 | 09/113,094 | IR14 |
| PP0877 | 09/112,760 | IR16 |
| PP0878 | 6,196,739 | IR17 |
| PP0879 | 09/112,774 | IR18 |
| PP0883 | 6,270,182 | IR19 |
| PP0880 | 6,152,619 | IR20 |
| PP0881 | 09/113,092 | IR21 |
| PO8006 | 6,087,638 | MEMS02 |
| PO8007 | 09/113,093 | MEMS03 |
| PO8008 | 09/113,062 | MEMS04 |
| PO8010 | 6,041,600 | MEMS05 |
| PO8011 | 09/113,082 | MEMS06 |
| PO7947 | 6,067,797 | MEMS07 |
| PO7944 | 09/113,080 | MEMS09 |
| PO7946 | 6,044,646 | MEMS10 |
| PO9393 | 09/113,065 | MEMS11 |
| PP0875 | 09/113,078 | MEMS12 |
| PP0894 | 09/113,075 | MEMS13 |

### FIELD OF THE INVENTION

The present invention relates substantially to the concept of a disposable camera having instant printing capabilities and in particular, discloses a method of color correction in a digital camera.

### BACKGROUND OF THE INVENTION

Recently, the concept of a “single use” disposable camera has become an increasingly popular consumer item. Disposable camera systems presently on the market normally include an internal film roll and a simplified gearing mechanism for traversing the film roll across an imaging system including a shutter and lensing system. The user, after utilising a single film roll returns the camera system to a film development centre for processing. The film roll is taken out of the camera system and processed and the prints returned to the user. The camera system is then able to be re-manufactured through the insertion of a new film roll into the camera system, the replacement of any worn or wearable parts and the re-packaging of the camera system in accordance with requirements. In this way, the concept of a single use “disposable” camera is provided to the consumer.

Recently, a camera system has been proposed by the present applicant which provides for a handheld camera device having an internal printhead, image sensor and processing means such that images sense by the image sensing means, are processed by the processing means and adapted to be instantly printed out by the printing means on demand. The proposed camera system further discloses a system of internal “print rolls” carrying print media such as film on to which images are to be printed in addition to ink for supplying to the printing means for the printing process. The print roll is further disclosed to be detachable and replaceable within the camera system.

Unfortunately, such a system is likely to only be constructed at a substantial cost and it would be desirable to provide for a more inexpensive form of instant camera system which maintains a substantial number of the quality aspects of the aforementioned arrangement.

It would be advantageous to provide for a camera system having an effective color correction or gamma remapping capability.

### SUMMARY OF THE INVENTION

It is an object of the present invention to provide for an efficient and effective color correction capabilities for a camera system.

In accordance with a first aspect of the present invention, there is provided in a camera system including: an image sensor device for sensing an image; a processing means for processing the sensed image; and a printing system for printing out the sensed image; a method of color correcting a sensed image to be printed out by the printhead, comprising: utilizing the image sensor device to sense a first image; processing the first image to determine color characteristics of a first sensed image; utilizing the image sensor device to sense a second image, in rapid succession to the first image; applying color correction methods to the second image based on the determined color characteristics of the first sensed image; and printing out the second image.

In a further preferred embodiment of the present invention there is provided a portable camera system a method of color correcting a sensed image, the method including the steps of:

obtaining a first image;

determining color characteristics of said first image;

obtaining a second image in rapid succession to said first image; and

applying color correction to said second image based on the determined color characteristics of said first image to produce a modified second image.

Preferably, the second sensed image is sensed within 1 second of the first sensed image and the processing step includes examining the intensity characteristics of the first image. The processing step can include determining a maximum and minimum intensity of the first image and utilizing the intensities to rescale the intensities of the second image.

### BRIEF DESCRIPTION OF THE DRAWINGS

Notwithstanding any other forms which may fall within the scope of the present invention, preferred forms of the invention will now be described, by way of example only, with reference to the accompanying drawings in which:

FIG. 1 illustrates a front perspective view of the assembled camera of the preferred embodiment;

FIG. 2 illustrates a rear perspective view, partly exploded, of the preferred embodiment;

FIG. 3 is a perspective view of the chassis of the preferred embodiment;

FIG. 4 is a perspective view of the chassis illustrating mounting of electric motors;

FIG. 5 is an exploded perspective view of the ink supply mechanism of the preferred embodiment;

FIG. 6 is rear perspective of the assembled form of the ink supply mechanism of the preferred embodiment;

FIG. 7 is a front perspective view of the assembled form of the ink supply mechanism of the preferred embodiment;

FIG. 8 is an exploded perspective view of the platten unit of the preferred embodiment;

FIG. 9 is a perspective view of the assembled form of the platten unit;

FIG. 10 is also a perspective view of the assembled form of the platten unit;

FIG. 11 is an exploded perspective view of the printhead recapping mechanism of the preferred embodiment;

FIG. 12 is a close up exploded perspective view of the recapping mechanism of the preferred embodiment;

FIG. 13 is an exploded perspective view of the ink supply cartridge of the preferred embodiment;

FIG. 14 is a close up perspective view, partly in section of the internal portions of the ink supply cartridge in an assembled form;

FIG. 15 is a schematic block diagram of one form of chip layer of the image capture and processing chip of the preferred embodiment;

FIG. 16 is an exploded perspective view illustrating the assembly process of the preferred embodiment;

FIG. 17 illustrates a front exploded perspective view of the assembly process of the preferred embodiment;

FIG. 18 illustrates a perspective view of the assembly process of the preferred embodiment;

FIG. 19 illustrates a perspective view of the assembly process of the preferred embodiment;

FIG. 20 is a perspective view illustrating the insertion of the platten unit in the preferred embodiment;

FIG. 21 illustrates the interconnection of the electrical components of the preferred embodiment;

FIG. 22 illustrates the process of assembling the preferred embodiment; and

FIG. 23 is a perspective view further illustrating the assembly process of the preferred embodiment.

### DESCRIPTION OF PREFERRED AND OTHER EMBODIMENTS

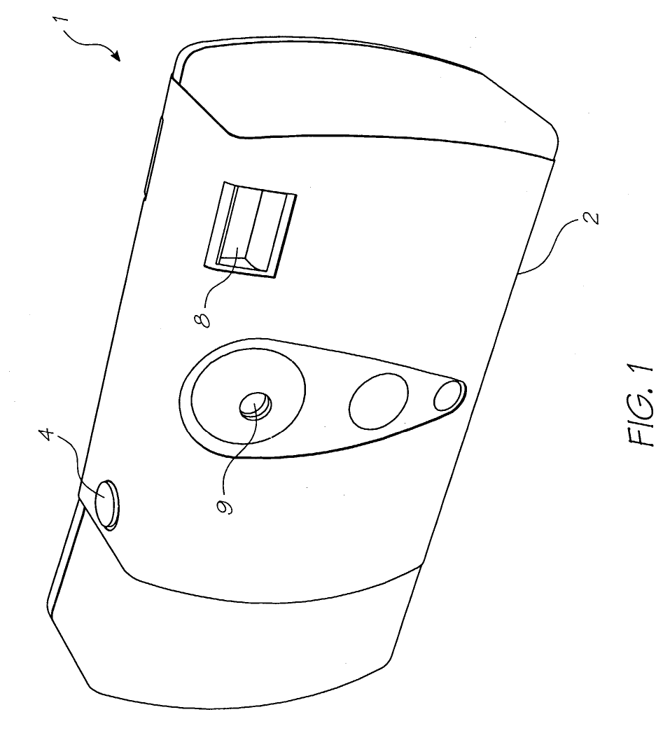

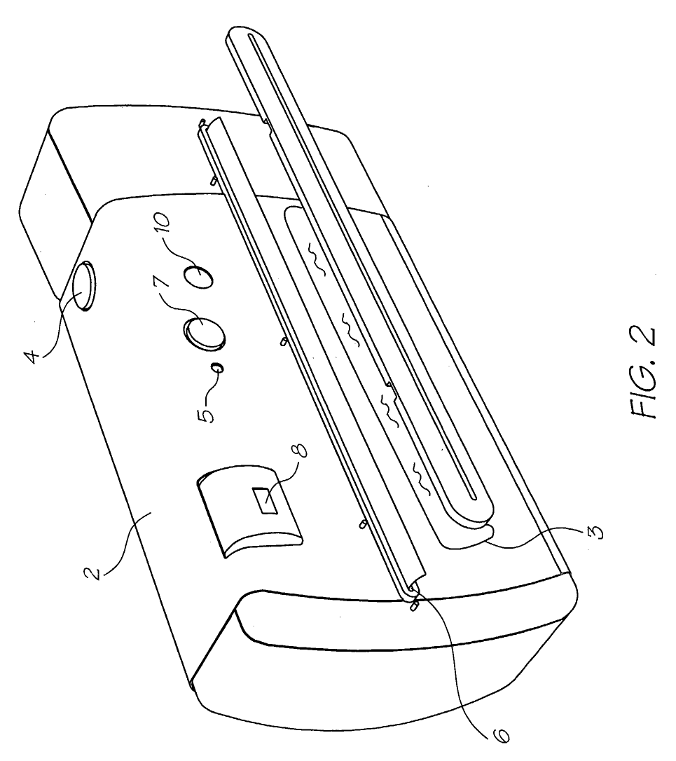

Turning to FIG. 1 and FIG. 2 there an illustrated perspective views of an assembled camera constructed in accordance with the preferred embodiment with FIG. 1 showing a front perspective view and FIG. 2 showing a rear perspective view. The camera 1 includes a paper or plastic film jacket 2 which can include simplified instructions 3 for the operation of the camera system 1. The camera system 1 includes a first “take” button 4 which is depressed to capture an image. The captured image is output via output slot 6. A further copy of the image can be obtained through depressing a second “printer copy” button 7 whilst an LED light 5 is illuminated. The camera system also provides the usual view finder 8 in addition to a CCD image capture/lensing system 9.

The camera system 1 provides for a standard number of output prints after which the camera system 1 ceases to function. A prints left indicator slot 10 is provided to indicate the number of remaining prints. A refund scheme at the point of purchase is assumed to be operational for the return of used camera systems for recycling.

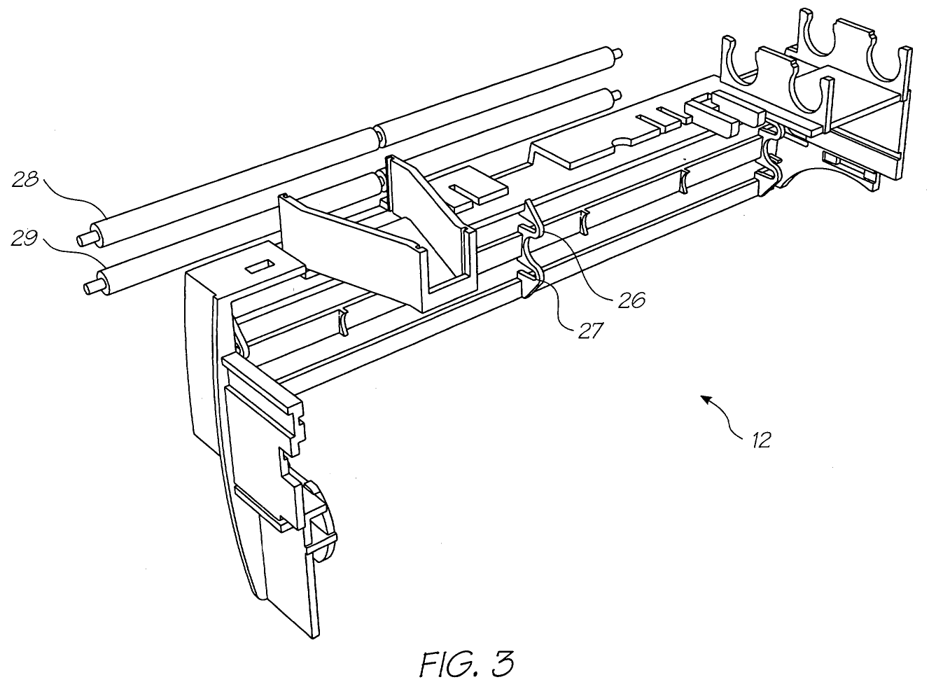

Turning now to FIG. 3, the assembly of the camera system is based around an internal chassis 12 which can be a plastic injection molded part. A pair of paper pinch rollers 28, 29 utilized for decurling are snap fitted into corresponding frame holes eg. 26, 27.

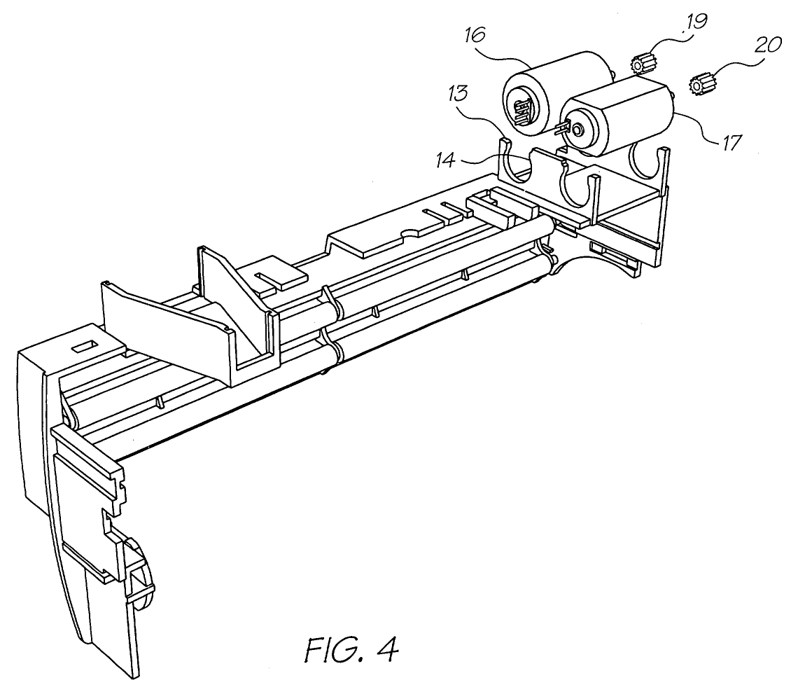

As shown in FIG. 4, the chassis 12 includes a series of mutually opposed prongs eg. 13, 14 into which is snap fitted a series of electric motors 16, 17. The electric motors 16, 17 can be entirely standard with the motor 16 being of a stepper motor type. The motors_16, 17 and include cogs 19, 20 for driving a series of gear wheels. A first set of gear wheels is provided for controlling a paper cutter mechanism and a second set is provided for controlling print roll movement.

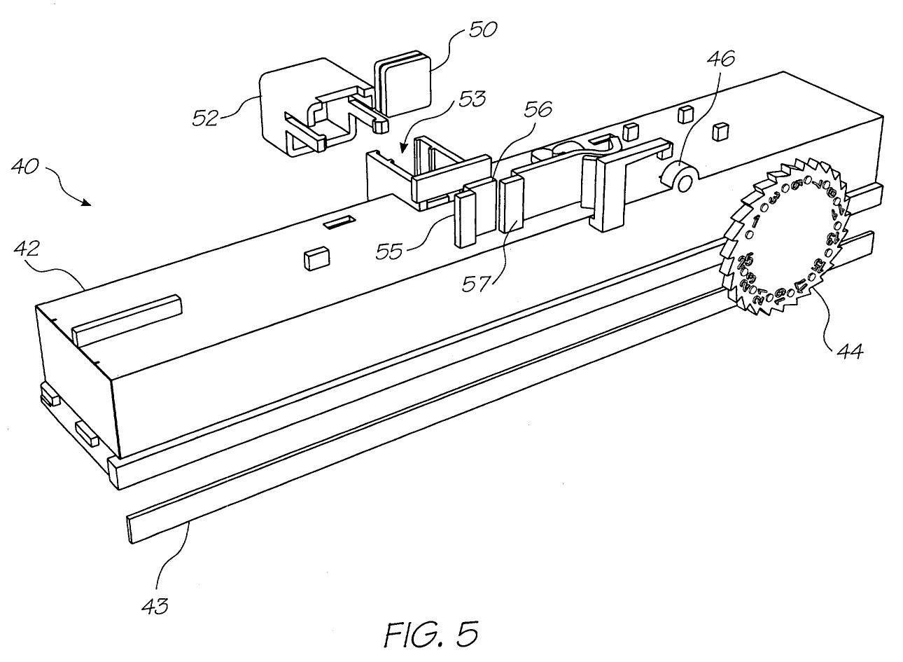

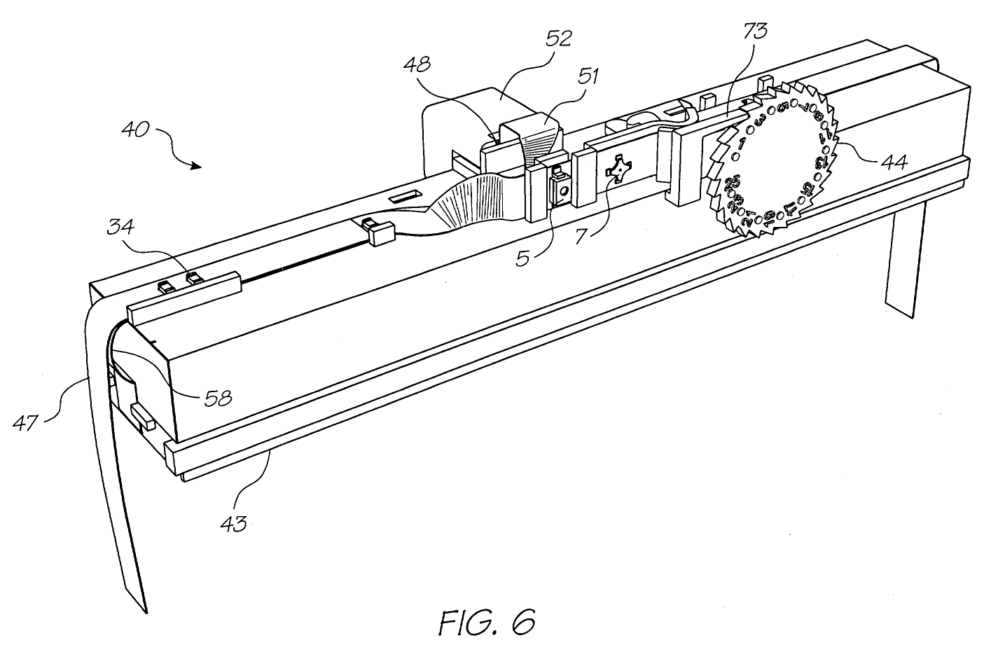

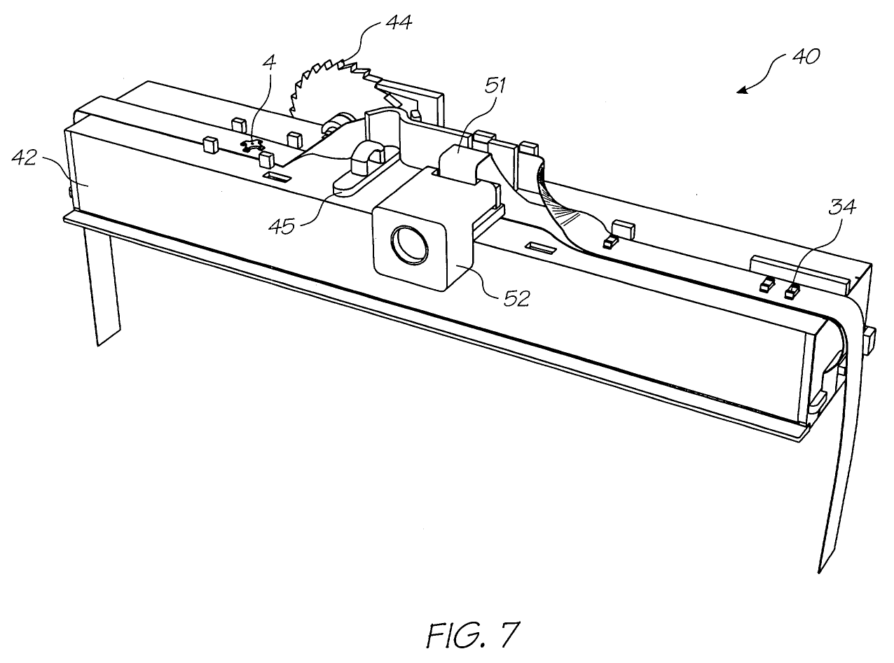

Turning next to FIGS. 5 to 7, there is illustrated an ink supply mechanism 40 utilized in the camera system. FIG. 5 illustrates a rear exploded perspective view, FIG. 6 illustrates a assembled perspective view and FIG. 7 illustrates a front assembled view. The ink supply mechanism 40 is based around an ink supply cartridge 42 which contains printer ink and a printhead mechanism for printing out pictures on demand. The ink supply cartridge 42 includes a side aluminium strip 43 which is provided as a shear strip to assist in cutting images from a paper roll.

A dial mechanism 44 is provided for indicating the number of “prints left”. The dial mechanism 44 is snap fitted through a corresponding mating portion 46 so as to be freely rotatable.

As shown in FIG. 6, the mechanism 40 includes a flexible PCB strip 47 which interconnects with the printhead and provides for control of the printhead. The interconnection between the Flex PCB strip and an image sensor and printhead chip can be via Tape Automated Bonding (TAB) strips 51, 58. A moulded aspherical lens and aperture shim 50 (FIG. 5) is also provided for imaging an image onto the surface of the image sensor chip normally located within cavity 53 and a light box module or hood 52 is provided for snap fitting over the cavity 53 so as to provide for proper light control. A series of decoupling capacitors eg. 34 can also be provided. Further a plug 45 (FIG. 7) is provided for re-plugging ink holes after refilling. A series of guide prongs eg. 55-57 are further provided for guiding the flexible PCB strip 47.

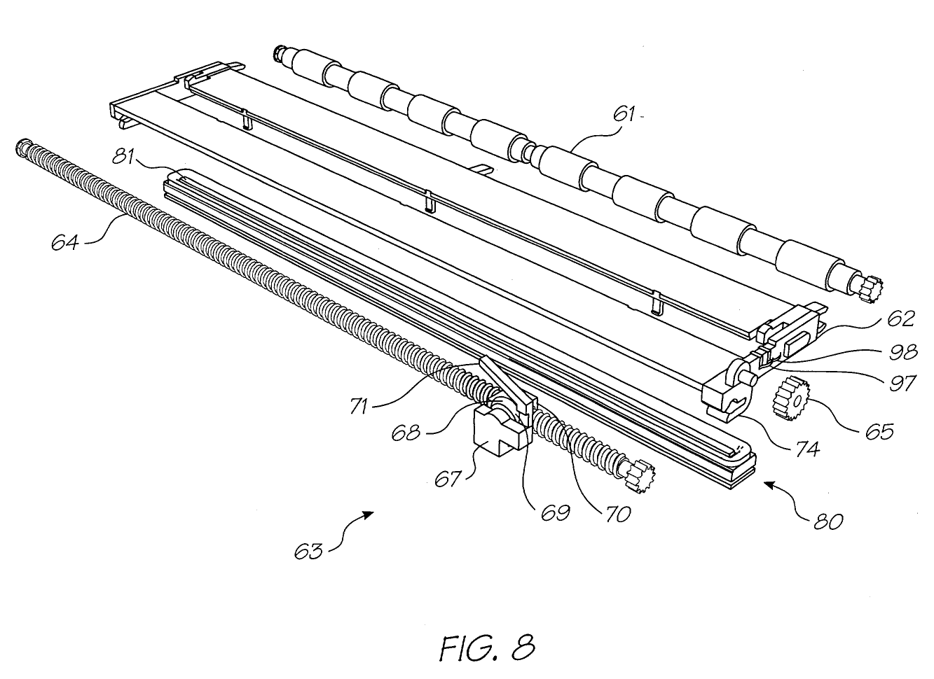

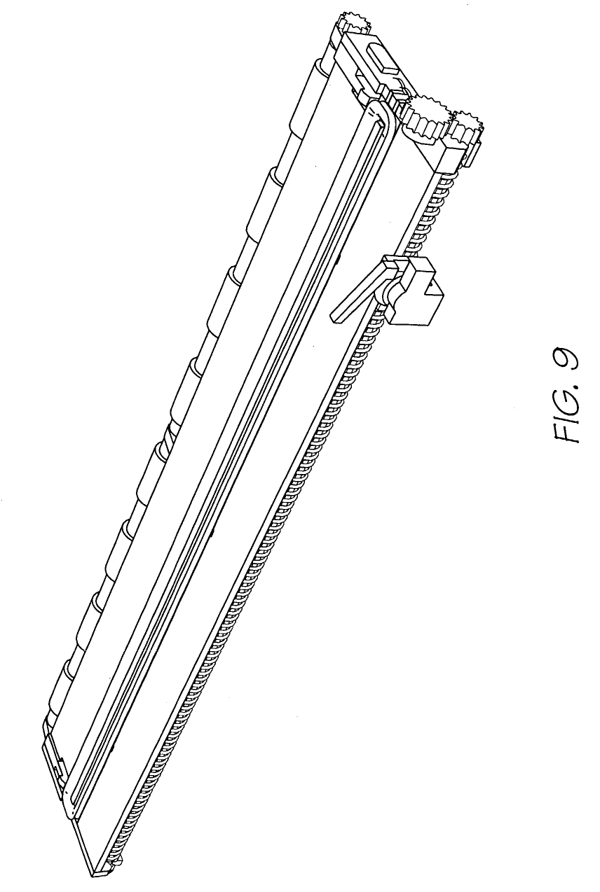

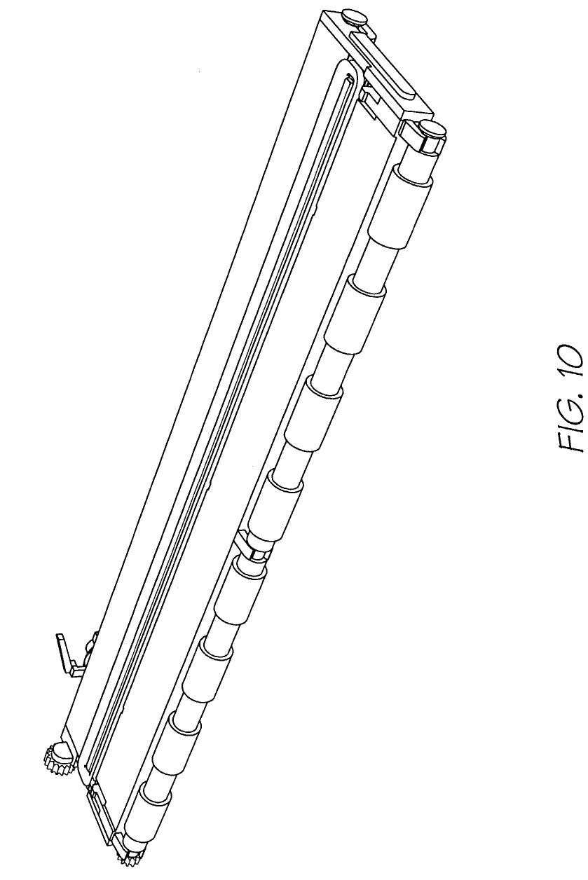

The ink supply mechanism 40 interacts with a platten unit 60 which guides print media under a printhead located in the ink supply mechanism. FIG. 8 shows an exploded view of the platten unit 60, while FIGS. 9 and 10 show assembled views of the platten unit. The platten unit 60 includes a first pinch roller 61 which is snap fitted to one side of a platten base 62. Attached to a second side of the platten base 62 is a cutting mechanism 63 which traverses the platen unit 60 by means of a rod 64 having a screw thread which is rotated by means of cogged wheel 65 which is also fitted to the platen base 62. The screw thread rod 64 mounts a block 67 which includes a cutting wheel 68 fastened via a fastener 69. Also mounted to the block 67 is a counter actuator which includes a pawl 71. The pawl 71 acts to rotate the dial mechanism 44 of FIG. 6 upon the return traversal of the cutting wheel. As shown previously in FIG. 6, the dial mechanism 44 includes a cogged surface which interacts with pawl 71, thereby maintaining a count of the number of photographs by means of numbers embossed on the surface of dial mechanism 44. The cutting mechanism 63 is inserted into the platten base 62 by means of a snap fit via clips 74.

The platten unit 60 includes an internal recapping mechanism 80 for recapping the printhead when not in use. The recapping mechanism 80 includes a sponge portion 81 and is operated via a solenoid coil so as to provide for recapping of the printhead. In the preferred embodiment, there is provided an inexpensive form of printhead re-capping mechanism provided for incorporation into a handheld camera system so as to provide for printhead re-capping of an inkjet printhead.

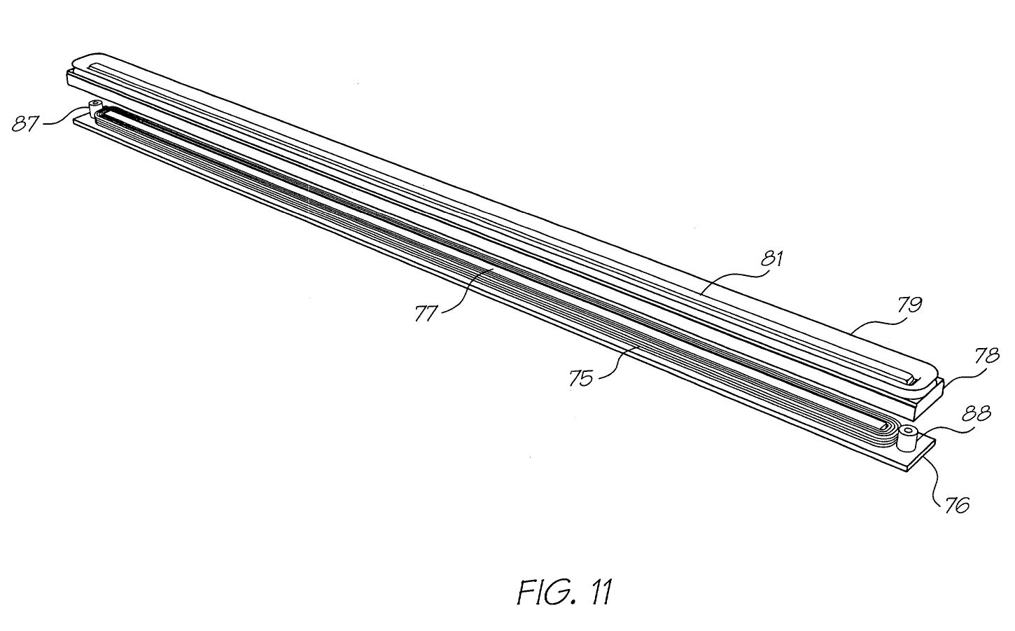

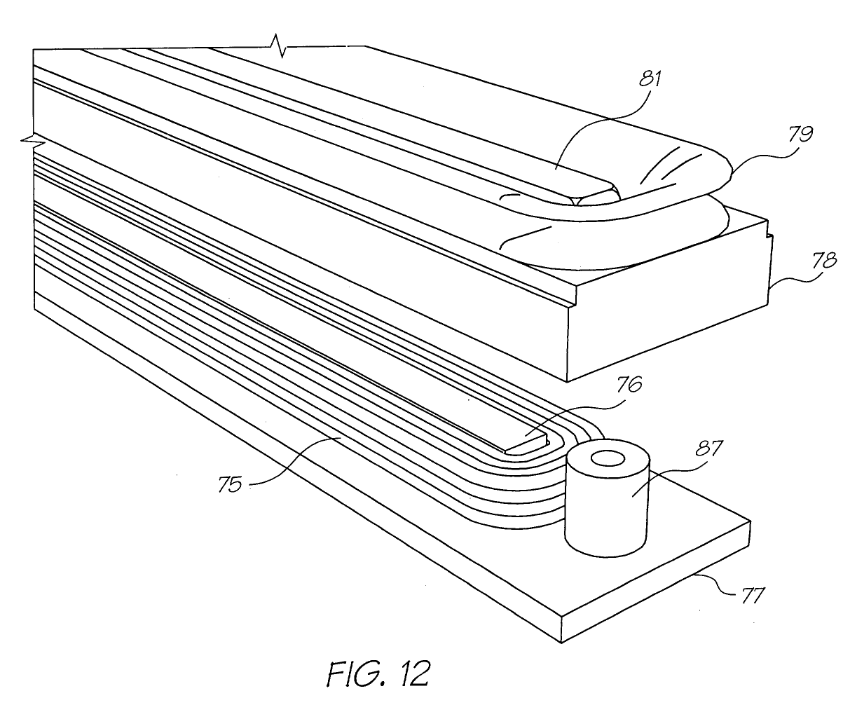

FIG. 11 illustrates an exploded view of the recapping mechanism whilst FIG. 12 illustrates a close up of the end portion thereof. The re-capping mechanism 80 is structured around a solenoid including a 16 turn coil 75 which can comprise insulated wire. The coil 75 is turned around a first stationery solenoid arm 76 which is mounted on a bottom surface of the platten base 62 (FIG. 8) and includes a post portion 77 to magnify effectiveness of operation. The arm 76 can comprise a ferrous material.

A second moveable arm 78 of the solenoid actuator is also provided. The arm 78 is moveable and also is made of ferrous material. Mounted on the arm is a sponge portion surrounded by an elastomer strip 79. The elastomer strip 79 is of a generally arcuate cross-section and acts as a leaf spring against the surface of the printhead ink supply cartridge 42 (FIG. 5) so as to provide for a seal against the surface of the printhead ink supply cartridge 42. In the quiescent position elastomer spring units 87, 88 act to resiliently deform the elastomer seal 79 against the surface of the ink supply unit 42.

When it is desired to operate the printhead unit, upon the insertion of paper, the solenoid coil 75 is activated so as to cause the arm 78 to move down to be adjacent to the end plate 76. The arm 78 is held against end plate 76 while the printhead is printing by means of a small “keeper current” in coil 75. Simulation results indicate that the keeper current can be significantly less than the actuation current. Subsequently, after photo printing, the paper is guillotined by the cutting mechanism 63 of FIG. 8 acting against Aluminium Strip 43, and rewound so as to clear the area of the re-capping mechanism 80. Subsequently, the current is turned off and springs 87, 88 return the arm 78 so that the elastomer seal is again resting against the printhead ink supply cartridge.

It can be seen that the preferred embodiment provides for a simple and inexpensive means of re-capping a printhead through the utilisation of a solenoid type device having a long rectangular form. Further, the preferred embodiment utilises minimal power in that currents are only required whilst the device is operational and additionally, only a low keeper current is required whilst the printhead is printing.

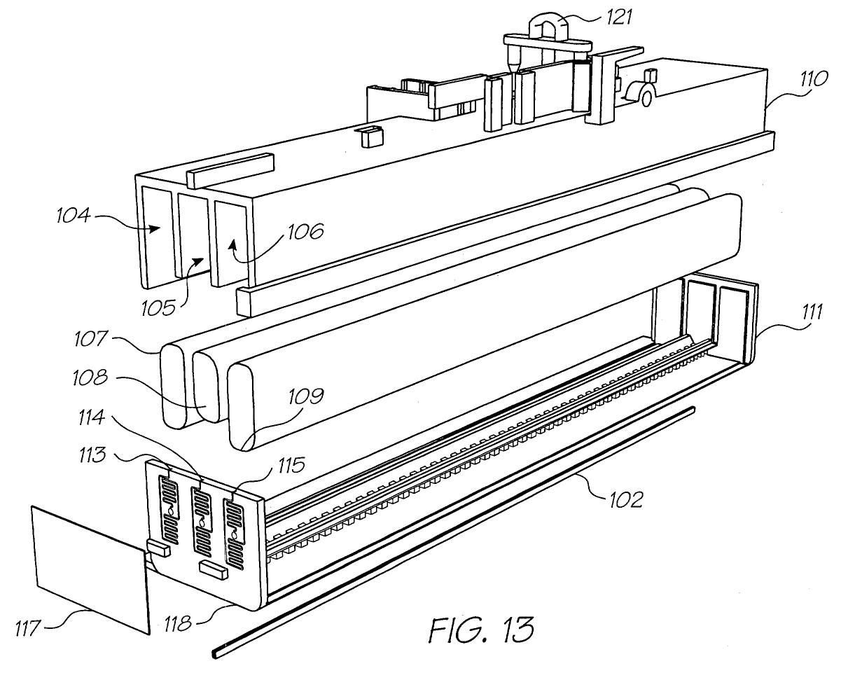

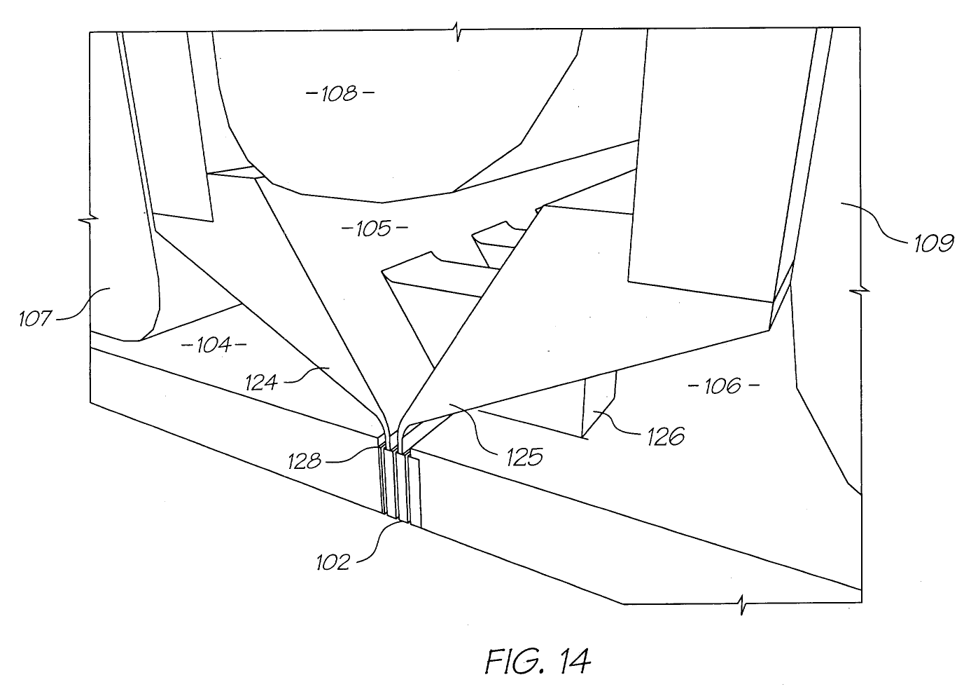

Turning next to FIGS. 13 and 14, FIG. 13 illustrates an exploded perspective of the ink supply cartridge 42 whilst FIG. 14 illustrates a close up sectional view of a bottom of the ink supply cartridge with the printhead unit in place. The ink supply cartridge 42 is based around a pagewidth printhead 102 which comprises a long slither of silicon having a series of holes etched on the back surface for the supply of ink to a front surface of the silicon wafer for subsequent ejection via a micro electro mechanical system. The form of ejection can be many different forms such as those set out in the tables below.

Of course, many other inkjet technologies, as referred to the attached tables below, can also be utilised when constructing a printhead unit 102. The fundamental requirement of the ink supply cartridge 42 is the supply of ink to a series of colour channels etched through the back surface of the printhead 102. In the description of the preferred embodiment, it is assumed that a three colour printing process is to be utilised so as to provide full colour picture output. Hence, the print supply unit includes three ink supply reservoirs being a cyan reservoir 104, a magenta reservoir 105 and a yellow reservoir 106. Each of these reservoirs is required to store ink and includes a corresponding sponge type material 107-109 which assists in stabilising ink within the corresponding ink channel and inhibiting the ink from sloshing back and forth when the printhead is utilised in a handheld camera system. The reservoirs 104, 105, 106 are formed through the mating of first exterior plastic piece 110 and a second base piece 111.

At a first end 118 of the base piece 111 a series of air inlets 113-115 are provided. Each air inlet leads to a corresponding winding channel which is hydrophobically treated so as to act as an ink repellent and therefore repel any ink that may flow along the air inlet channel. The air inlet channel further takes a convoluted path further assisting in resisting any ink flow out of the chambers 104-106. An adhesive tape portion 117 is provided for sealing the channels within end portion 118.

At the top end, there is included a series of refill holes (not shown) for refilling corresponding ink supply chambers 104, 105, 106. A plug 121 is provided for sealing the refill holes.

Turning now to FIG. 14, there is illustrated a close up perspective view, partly in section through the ink supply cartridge 42 of FIG. 13 when formed as a unit. The ink supply cartridge includes the three colour ink reservoirs 104, 105, 106 which supply ink to different portions of the back surface of printhead 102 which includes a series of apertures 128 defined therein for carriage of the ink to the front surface.

The ink supply cartridge 42 includes two guide walls 124, 125 which separate the various ink chambers and are tapered into an end portion abutting the surface of the printhead 102. The guide walls 124, 125 are further mechanically supported by block portions eg. 126 which are placed at regular intervals along the length of the ink supply unit. The block portions 126 leave space at portions close to the back of printhead 102 for the flow of ink around the back surface thereof.

The ink supply unit is preferably formed from a multi-part plastic injection mold and the mold pieces eg. 110, 111 (FIG. 13) snap together around the sponge pieces 107, 109. Subsequently, a syringe type device can be inserted in the ink refill holes and the ink reservoirs filled with ink with the air flowing out of the air outlets 113-115. Subsequently, the adhesive tape portion 117 and plug 121 are attached and the printhead tested for operation capabilities. Subsequently, the ink supply cartridge 42 can be readily removed for refilling by means of removing the ink supply cartridge, performing a washing cycle, and then utilising the holes for the insertion of a refill syringe filled with ink for refilling the ink chamber before returning the ink supply cartridge 42 to a camera.

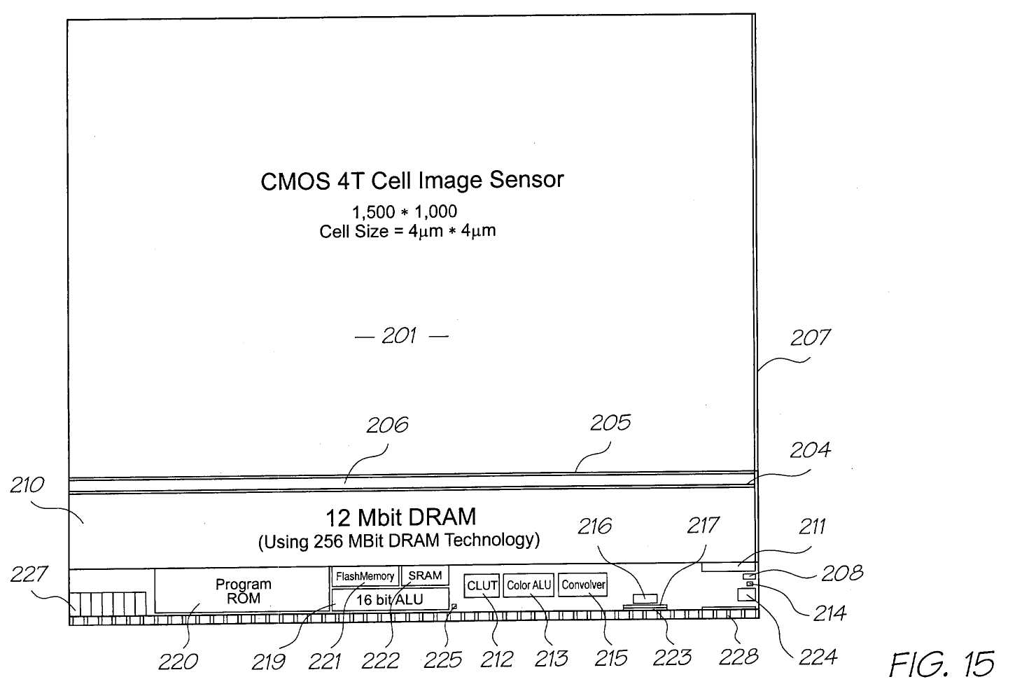

Turning now to FIG. 15, there is shown an example layout of the Image Capture and Processing Chip (ICP) 48. The Image Capture and Processing Chip 48 provides most of the electronic functionality of the camera with the exception of the printhead chip. The chip 48 is a highly integrated system. It combines CMOS image sensing, analog to digital conversion, digital image processing, DRAM storage, ROM, and miscellaneous control functions in a single chip.

The chip is estimated to be around 32 mm² using a leading edge 0.18 micron CMOS/DRAM/APS process. The chip size and cost can scale somewhat with Moore's law, but is dominated by a CMOS active pixel sensor array 201, so scaling is limited as the sensor pixels approach the diffraction limit.

The ICP 48 includes CMOS logic, a CMOS image sensor, DRAM, and analog circuitry. A very small amount of flash memory or other non-volatile memory is also preferably included for protection against reverse engineering.

Alternatively, the ICP can readily be divided into two chips: one for the CMOS imaging array, and the other for the remaining circuitry. The cost of this two chip solution should not be significantly different than the single chip ICP, as the extra cost of packaging and bond-pad area is somewhat cancelled by the reduced total wafer area requiring the color filter fabrication steps.

The ICP preferably contains the following functions:

Function
1.5 megapixel image sensor
Analog Signal Processors
Image sensor column decoders
Image sensor row decoders
Analogue to Digital Conversion (ADC)
Column ADC's
Auto exposure
12 Mbits of DRAM
DRAM Address Generator
Color interpolator
Convolver
Color ALU
Halftone matrix ROM
Digital halftoning
printhead interface
8 bit CPU core
Program ROM
Flash memory
Scratchpad SRAM
Parallel interface (8 bit)
Motor drive transistors (5)
Clock PLL
JTAG test interface
Test circuits
Busses
Bond pads

The CPU, DRAM, Image sensor, ROM, Flash memory, Parallel interface, JTAG interface and ADC can be vendor supplied cores. The ICP is intended to run on 1.5V to minimize power consumption and allow convenient operation from two AA type battery cells.

FIG. 15 illustrates a layout of the ICP 48. The ICP 48 is dominated by the imaging array 201, which consumes around 80% of the chip area. The imaging array is a CMOS 4 transistor active pixel design with a resolution of 1,500×1,000. The array can be divided into the conventional configuration, with two green pixels, one red pixel, and one blue pixel in each pixel group. There are 750×500 pixel groups in the imaging array.

The latest advances in the field of image sensing and CMOS image sensing in particular can be found in the October, 1997 issue of IEEE Transactions on Electron Devices and, in particular, pages 1689 to 1968. Further, a specific implementation similar to that disclosed in the present application is disclosed in Wong et. al, “CMOS Active Pixel Image Sensors Fabricated Using a 1.8V, 0.25 μm CMOS Technology”, IEDM 1996, page 915

The imaging array uses a 4 transistor active pixel design of a standard configuration. To minimize chip area and therefore cost, the image sensor pixels should be as small as feasible with the technology available. With a four transistor cell, the typical pixel size scales as 20 times the lithographic feature size. This allows a minimum pixel area of around 3.6 μm×3.6 μm. However, the photosite must be substantially above the diffraction limit of the lens. It is also advantageous to have a square photosite, to maximize the margin over the diffraction limit in both horizontal and vertical directions. In this case, the photosite can be specified as 2.5 μm×2.5 μm. The photosite can be a photogate, pinned photodiode, charge modulation device, or other sensor.

The four transistors are packed as an ‘L’ shape, rather than a rectangular region, to allow both the pixel and the photosite to be square. This reduces the transistor packing density slightly, increasing pixel size. However, the advantage in avoiding the diffraction limit is greater than the small decrease in packing density.

The transistors also have a gate length which is longer than the minimum for the process technology. These have been increased from a drawn length of 0.18 micron to a drawn length of 0.36 micron. This is to improve the transistor matching by making the variations in gate length represent a smaller proportion of the total gate length.

The extra gate length, and the ‘L’ shaped packing, mean that the transistors use more area than the minimum for the technology. Normally, around 8 μm² would be required for rectangular packing. Preferably, 9.75 μm² has been allowed for the transistors.

The total area for each pixel is 16 μm², resulting from a pixel size of 4 μm×4 μm. With a resolution of 1,500×1,000, the area of the imaging array 101 is 6,000 μm×4,000 μm, or 24 mm².

The presence of a color image sensor on the chip affects the process required in two major ways:

The CMOS fabrication process should be optimized to minimize dark current

Color filters are required. These can be fabricated using dyed photosensitive polyimides, resulting in an added process complexity of three spin coatings, three photolithographic steps, three development steps, and three hardbakes.

There are 15,000 analog signal processors (ASPs) 205, one for each of the columns of the sensor. The ASPs amplify the signal, provide a dark current reference, sample and hold the signal, and suppress the fixed pattern noise (FPN).

There are 375 analog to digital converters 206, one for each four columns of the sensor array. These may be delta-sigma or successive approximation type ADC's. A row of low column ADC's are used to reduce the conversion speed required, and the amount of analog signal degradation incurred before the signal is converted to digital. This also eliminates the hot spot (affecting local dark current) and the substrate coupled noise that would occur if a single high speed ADC was used. Each ADC also has two four bit DAC's which trim the offset and scale of the ADC to further reduce FPN variations between columns. These DAC's are controlled by data stored in flash memory during chip testing.

The column select logic 204 is a 1:1500 decoder which enables the appropriate digital output of the ADCs onto the output bus. As each ADC is shared by four columns, the least significant two bits of the row select control 4 input analog multiplexers.

A row decoder 207 is a 1:1000 decoder which enables the appropriate row of the active pixel sensor array. This selects which of the 1000 rows of the imaging array is connected to analog signal processors. As the rows are always accessed in sequence, the row select logic can be implemented as a shift register.

An auto exposure system 208 adjusts the reference voltage of the ADC 205 in response to the maximum intensity sensed during the previous frame period. Data from the green pixels is passed through a digital peak detector. The peak value of the image frame period before capture (the reference frame) is provided to a digital to analogue converter(DAC), which generates the global reference voltage for the column ADCs. The peak detector is reset at the beginning of the reference frame. The minimum and maximum values of the three RGB color components are also collected for color correction.

The second largest section of the chip is consumed by a DRAM 210 used to hold the image. To store the 1,500×1,000 image from the sensor without compression, 1.5 Mbytes of DRAM 210 are required. This equals 12 Mbits, or slightly less than 5% of a 256 Mbit DRAM. The DRAM technology assumed is of the 256 Mbit generation implemented using 0.18 μm CMOS.

Using a standard 8F cell, the area taken by the memory array is 3.11 mm². When row decoders, column sensors, redundancy, and other factors are taken into account, the DRAM requires around 4 mm².

This DRAM 210 can be mostly eliminated if analog storage of the image signal can be accurately maintained in the CMOS imaging array for the two seconds required to print the photo. However, digital storage of the image is preferable as it is maintained without degradation, is insensitive to noise, and allows copies of the photo to be printed considerably later.

A DRAM address generator 211 provides the write and read addresses to the DRAM 210. Under normal operation, the write address is determined by the order of the data read from the CMOS image sensor 201. This will typically be a simple raster format. However, the data can be read from the sensor 201 in any order, if matching write addresses to the DRAM are generated. The read order from the DRAM 210 will normally simply match the requirements of a color interpolator and the printhead. As the cyan, magenta, and yellow rows of the printhead are necessarily offset by a few pixels to allow space for nozzle actuators, the colors are not read from the DRAM simultaneously. However, there is plenty of time to read all of the data from the DRAM many times during the printing process. This capability is used to eliminate the need for FIFOs in the printhead interface, thereby saving chip area. All three RGB image components can be read from the DRAM each time color data is required. This allows a color space converter to provide a more sophisticated conversion than a simple linear RGB to CMY conversion.

Also, to allow two dimensional filtering of the image data without requiring line buffers, data is re-read from the DRAM array.

The address generator may also implement image effects in certain models of camera. For example, passport photos are generated by a manipulation of the read addresses to the DRAM. Also, image framing effects (where the central image is reduced), image warps, and kaleidoscopic effects can all be generated by manipulating the read addresses of the DRAM.

While the address generator 211 may be implemented with substantial complexity if effects are built into the standard chip, the chip area required for the address generator is small, as it consists only of address counters and a moderate amount of random logic.

A color interpolator 214 converts the interleaved pattern of red, 2× green, and blue pixels into RGB pixels. It consists of three 8 bit adders and associated registers. The divisions are by either 2 (for green) or 4 (for red and blue) so they can be implemented as fixed shifts in the output connections of the adders.

A convolver 215 is provided as a sharpening filter which applies a small convolution kernel (5×5) to the red, green, and blue planes of the image. The convolution kernel for the green plane is different from that of the red and blue planes, as green has twice as many samples. The sharpening filter has five functions:

To improve the color interpolation from the linear interpolation provided by the color interpolator, to a close approximation of a sync interpolation.

To compensate for the image ‘softening’ which occurs during digitization.

To adjust the image sharpness to match average consumer preferences, which are typically for the image to be slightly sharper than reality. As the single use camera is intended as a consumer product, and not a professional photographic products, the processing can match the most popular settings, rather than the most accurate.

To suppress the sharpening of high frequency (individual pixel) noise. The function is similar to the ‘unsharp mask’ process.

To antialias Image Warping.

These functions are all combined into a single convolution matrix. As the pixel rate is low (less than 1 Mpixel per second) the total number of multiplies required for the three color channels is 56 million multiplies per second. This can be provided by a single multiplier. Fifty bytes of coefficient ROM are also required.

A color ALU 113 combines the functions of color compensation and color space conversion into the one matrix multiplication, which is applied to every pixel of the frame. As with sharpening, the color correction should match the most popular settings, rather than the most accurate.

A color compensation circuit of the color ALU provides compensation for the lighting of the photo. The vast majority of photographs are substantially improved by a simple color compensation, which independently normalizes the contrast and brightness of the three color components.

A color look-up table (CLUT) 212 is provided for each color component. These are three separate 256×8 SRAMs, requiring a total of 6,144 bits. The CLUTs are used as part of the color correction process. They are also used for color special effects, such as stochastically selected “wild color” effects.

A color space conversion system of the color ALU converts from the RGB color space of the image sensor to the CMY color space of the printer. The simplest conversion is a 1's complement of the RGB data. However, this simple conversion assumes perfect linearity of both color spaces, and perfect dye spectra for both the color filters of the image sensor, and the ink dyes. At the other extreme is a tri-linear interpolation of a sampled three dimensional arbitrary transform table. This can effectively match any non-linearity or differences in either color space. Such a system is usually necessary to obtain good color space conversion when the print engine is a color electrophotographic.

However, since the non-linearity of a halftoned ink jet output is very small, a simpler system can be used. A simple matrix multiply can provide excellent results. This requires nine multiplies and six additions per contone pixel. However, since the contone pixel rate is low (less than 1 Mpixel/sec) these operations can share a single multiplier and adder. The multiplier and adder are used in a color ALU which is shared with the color compensation function.

Digital halftoning can be performed as a dispersed dot ordered dither using a stochastic optimized dither cell. A halftone matrix ROM 216 is provided for storing dither cell coefficients. A dither cell size of 32×32 is adequate to ensure that the cell repeat cycle is not visible. The three colors—cyan, magenta, and yellow—are all dithered using the same cell, to ensure maximum co-positioning of the ink dots. This minimizes ‘muddying’ of the mid-tones which results from bleed of dyes from one dot to adjacent dots while still wet. The total ROM size required is 1 KByte, as the one ROM is shared by the halftoning units for each of the three colors.

The digital halftoning used is dispersed dot ordered dither with stochastic optimized dither matrix. While dithering does not produce an image quite as ‘sharp’ as error diffusion, it does produce a more accurate image with fewer artifacts. The image sharpening produced by error diffusion is artificial, and less controllable and accurate than ‘unsharp mask’ filtering performed in the contone domain. The high print resolution (1,600 dpi×1,600 dpi) results in excellent quality when using a well formed stochastic dither matrix.

Digital halftoning is performed by a digital halftoning unit 217 using a simple comparison between the contone information from the DRAM 210 and the contents of the dither matrix 216. During the halftone process, the resolution of the image is changed from the 250 dpi of the captured contone image to the 1,600 dpi of the printed image. Each contone pixel is converted to an average of 40.96 halftone dots.

The ICP incorporates a 16 bit microcontroller CPU core 219 to run the miscellaneous camera functions, such as reading the buttons, controlling the motor and solenoids, setting up the hardware, and authenticating the refill station. The processing power required by the CPU is very modest, and a wide variety of processor cores can be used. As the entire CPU program is run from a small ROM 220, program compatibility between camera versions is not important, as no external programs are run. A 2 Mbit (256 Kbyte) program and data ROM 220 is included on chip. Most of this ROM space is allocated to data for outline graphics and fonts for specialty cameras. The program requirements are minor. The single most complex task is the encrypted authentication of the refill station. The ROM requires a single transistor per bit.

A Flash memory 221 may be used to store a 128 bit authentication code. This provides higher security than storage of the authentication code in ROM, as reverse engineering can be made essentially impossible. The Flash memory is completely covered by third level metal, making the data impossible to extract using scanning probe microscopes or electron beams. The authentication code is stored in the chip when manufactured. At least two other Flash bits are required for the authentication process: a bit which locks out reprogramming of the authentication code, and a bit which indicates that the camera has been refilled by an authenticated refill station. The flash memory can also be used to store FPN correction data for the imaging array. Additionally, a phase locked loop resealing parameter is stored and provided for scaling the clocking cycle to an appropriate correct time. The clock frequency does not require crystal accuracy since no date functions are provided. To eliminate the cost of a crystal, an on chip oscillator with a phase locked loop 224 is used. As the frequency of an on-chip oscillator is highly variable from chip to chip, the frequency ratio of the oscillator to the PLL is digitally trimmed during initial testing. The value is stored in Flash memory 221. This allows the clock PLL to control the ink-jet heater pulse width with sufficient accuracy.

A scratchpad SRAM is a small static RAM 222 with a 6T cell. The scratchpad provides temporary memory for the 16 bit CPU. 1024 bytes is adequate.

A printhead interface 223 formats the data correctly for the printhead. The printhead interface also provides all of the timing signals required by the printhead. These timing signals may vary depending upon temperature, the number of dots printed simultaneously, the print medium in the print roll, and the dye density of the ink in the print roll.

The following is a table of external connections to the [print head] printhead interface:

| Connection | Function | Pins |
|---|---|---|
| DataBits [0-7] | Independent serial data to the eight | 8 |
| | segments of the [print head] printhead | |
| BitClock | Main data clock for the [print head] | 1 |
| | printhead | |
| ColorEnable [0-2] | Independent enable signals for the CMY | 3 |
| | actuators, allowing different pulse times | |
| | for each color. | |
| BankEnable [0-1] | Allows either simultaneous or interleaved | 2 |
| | actuation of two banks of nozzles. This | |
| | allows two different print speed/power | |
| | consumption tradeoffs | |
| NozzleSelect [0-4] | Selects one of 32 banks of nozzles for | 5 |
| | simultaneous actuation | |
| ParallelXferClock | Loads the parallel transfer register with | 1 |
| | the data from the shift registers | |
| Total | | 20 |

The printhead utilized is composed of eight identical segments, each 1.25 cm long. There is no connection between the segments on the printhead chip. Any connections required are made in the external TAB bonding film, which is double sided. The division into eight identical segments is to simplify lithography using wafer steppers. The segment width of 1.25 cm fits easily into a stepper field. As the printhead chip is long and narrow (10 cm×0.3 mm), the stepper field contains a single segment of 32 printhead chips. The stepper field is therefore 1.25 cm×1.6 cm. An average of four complete printheads are patterned in each wafer step.

A single BitClock output line connects to all 8 segments on the printhead. The 8 DataBits lines lead one to each segment, and are clocked in to the 8 segments on the printhead simultaneously (on a BitClock pulse). For example, dot 0 is transferred to segment₀, dot 750 is transferred to segment₁, dot 1500 to segment₂ etc simultaneously.

The ParallelXferClock is connected to each of the 8 segments on the printhead, so that on a single pulse, all segments transfer their bits at the same time.

The NozzleSelect, BankEnable and ColorEnable lines are connected to each of the 8 segments, allowing the printhead interface to independently control the duration of the cyan, magenta, and yellow nozzle energizing pulses. Registers in the printhead Interface allow the accurate specification of the pulse duration between 0 and 6 ms, with a typical duration of 2 ms to 3 ms.

A parallel interface 125 connects the ICP to individual static electrical signals. The CPU is able to control each of these connections as memory mapped I/O via a low speed bus.

The following is a table of connections to the parallel interface:

| Connection | Direction | Pins |
|---|---|---|
| Paper transport stepper motor | Output | 4 |
| Capping solenoid | Output | 1 |
| Copy LED | Output | 1 |
| Photo button | Input | 1 |
| Copy button | Input | 1 |
| Total | | 8 |

Seven high current drive transistors eg. 227 are required. Four are for the four phases of the main stepper motor, two are for the guillotine motor, and the remaining transistor is to drive the capping solenoid. These transistors are allocated 20,000 square microns (600,000 F) each. As the transistors are driving highly inductive loads, they must either be turned off slowly, or be provided with a high level of back EMF protection. If adequate back EMF protection cannot be provided using the chip process chosen, then external discrete transistors should be used. The transistors are never driven at the same time as the image sensor is used. This is to avoid voltage fluctuations and hot spots affecting the image quality. Further, the transistors are located as far away from the sensor as possible.

A standard JTAG (Joint Test Action Group) interface 228 is included in the ICP for testing purposes and for interrogation by the refill station. Due to the complexity of the chip, a variety of testing techniques are required, including BIST (Built In Self Test) and functional block isolation. An overhead of 10% in chip area is assumed for chip testing circuitry for the random logic portions. The overhead for the large arrays, the image sensor and the DRAM is smaller.

The JTAG interface is also used for authentication of the refill station. This is included to ensure that the cameras are only refilled with quality paper and ink at a properly constructed refill station, thus preventing inferior quality refills from occurring. The camera must authenticate the refill station, rather than vice versa. The secure protocol is communicated to the refill station during the automated test procedure. Contact is made to four gold plated spots on the ICP/printhead TAB by the refill station as the new ink is injected into the printhead.

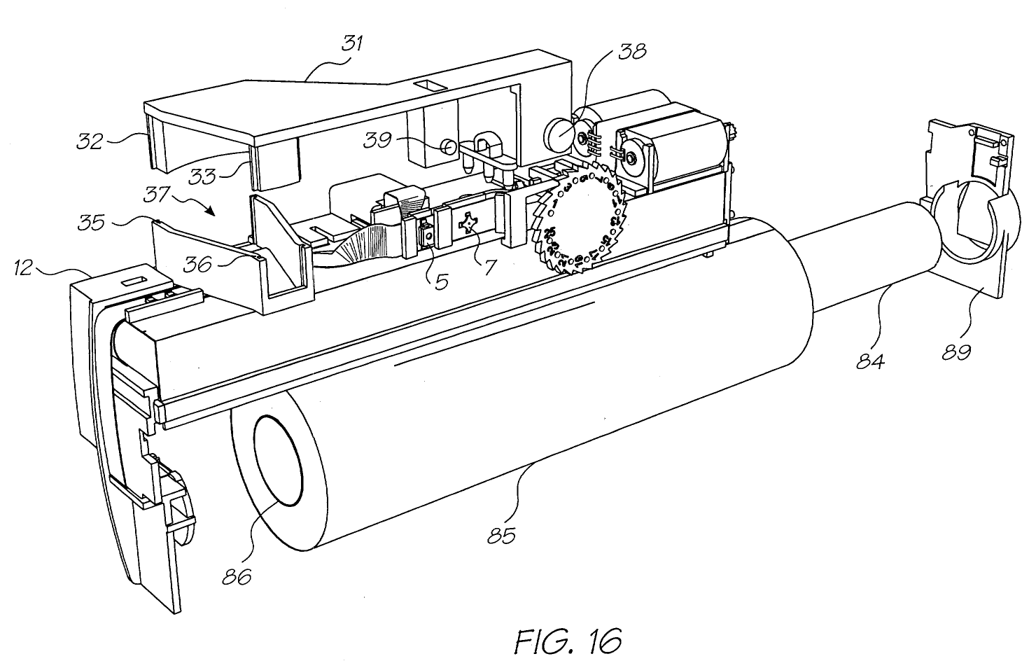

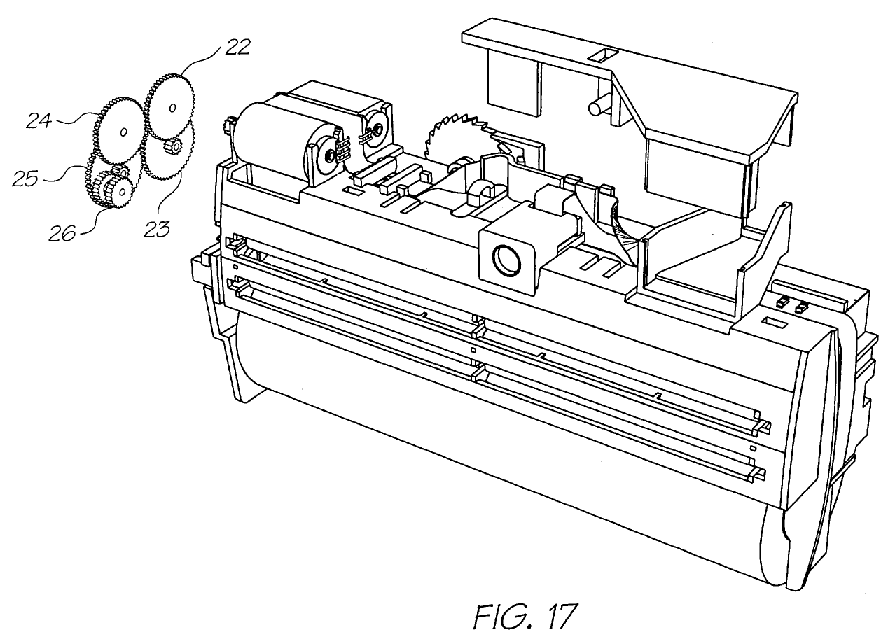

FIG. 16 illustrates a rear view of the next step in the construction process whilst FIG. 17 illustrates a front camera view.

Turning now to FIG. 16, the assembly of the camera system proceeds via first assembling the ink supply mechanism 40. The flex PCB is interconnected with batteries 84 only one of which is shown, which are inserted in the middle portion of a print roll 85 which is wrapped around a plastic former 86. An end cap 89 is provided at the other end of the print roll 85 so as to fasten the print roll and batteries firmly to the ink supply mechanism.

The solenoid coil is interconnected (not shown) to interconnects 97, 98 (FIG. 8) which include leaf spring ends for interconnection with electrical contacts on the Flex PCB so as to provide for electrical control of the solenoid.

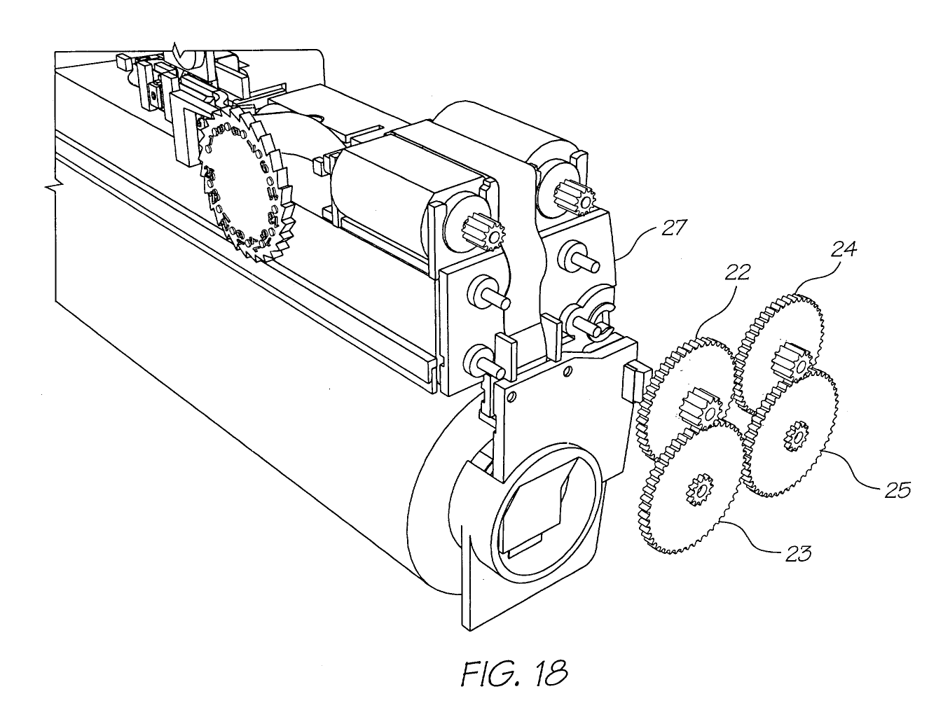

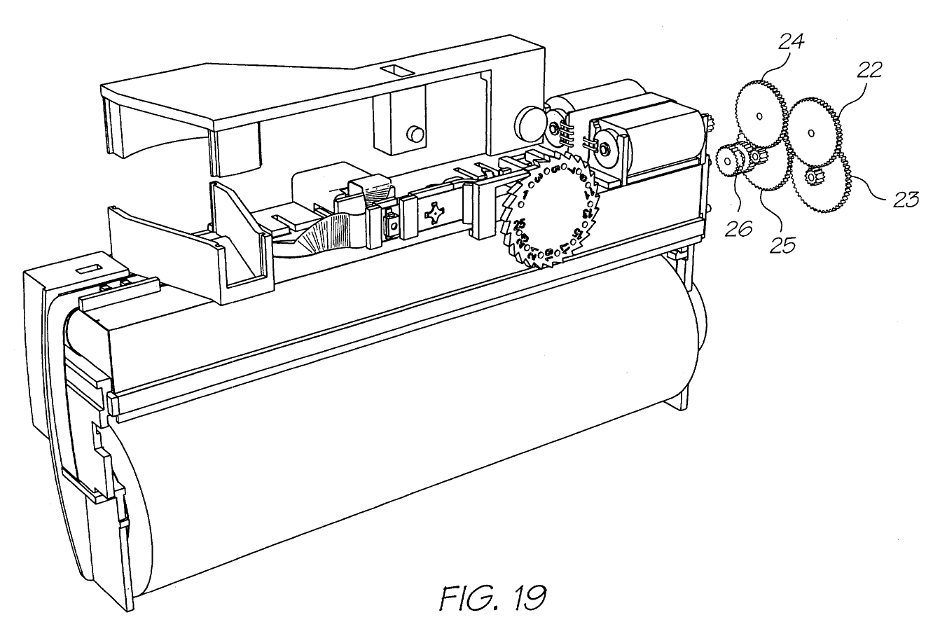

Turning now to FIGS. 17-19 the next step in the construction process is the insertion of the relevant gear trains into the side of the camera chassis. FIG. 17 illustrates a front view. FIG. 18 illustrates a rear view and FIG. 19 also illustrates a rear view. The first gear trains comprising gear wheels 22, 23 are utilised for driving the guillotine blade with the gear wheel 23 engaging the gear wheel 65 of FIG. 8. The second gear chain comprising gear wheels 24, 25 and 26 engage one end of the print roller 61 of FIG. 8. As best indicated in FIG. 18, the gear wheels mate with corresponding pins on the surface of the chassis with the gear wheel 26 being snap fitted into corresponding mating hole 27.

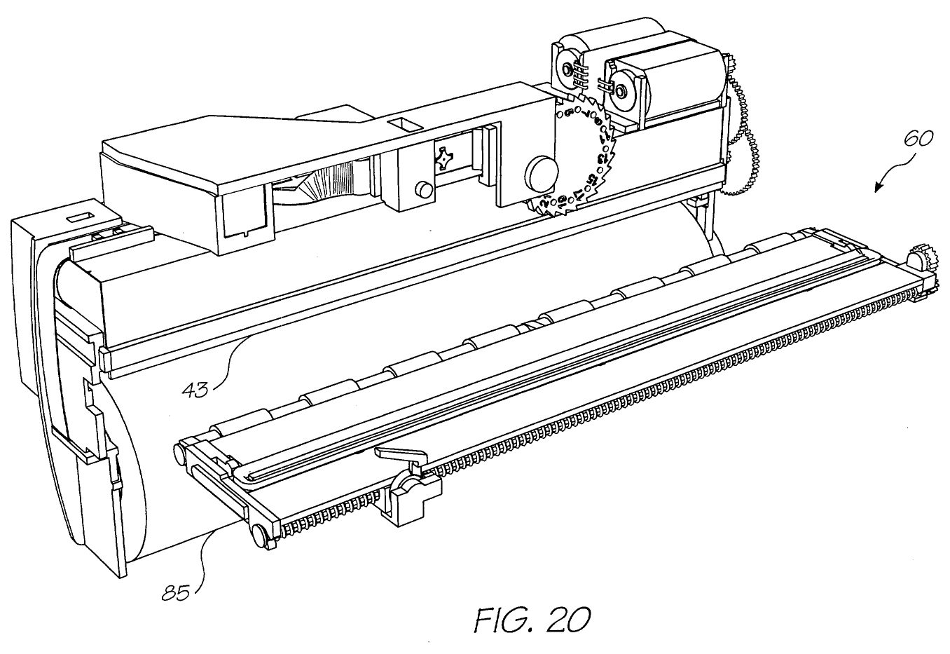

Next, as illustrated in FIG. 20, the assembled platten unit 60 is then inserted between the print roll 85 and aluminium cutting blade 43.

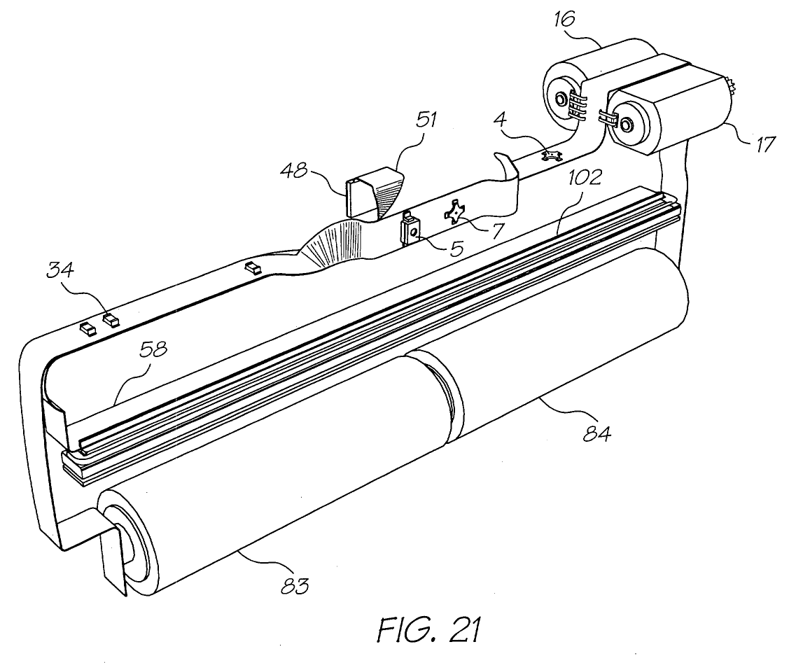

Turning now to FIG. 21, by way of illumination, there is illustrated the electrically interactive components of the camera system. As noted previously, the components are based around a Flex PCB board and include a TAB film 58 which interconnects the printhead 102 with the image sensor and processing chip 48. Power is supplied by two AA type batteries 83, 84 and a paper drive stepper motor 16 is provided in addition to a rotary guillotine motor 17.

An optical element 31 is provided for snapping into a top portion of the chassis 12. The optical element 31 includes portions defining an optical view finder 32, 33 which are slotted into mating portions 35, 36 in view finder channel 37. Also provided in the optical element 31 is a lensing system 38 for magnification of the “prints left” number in addition to an optical pipe element 39 for piping light from the LED 5 for external display.

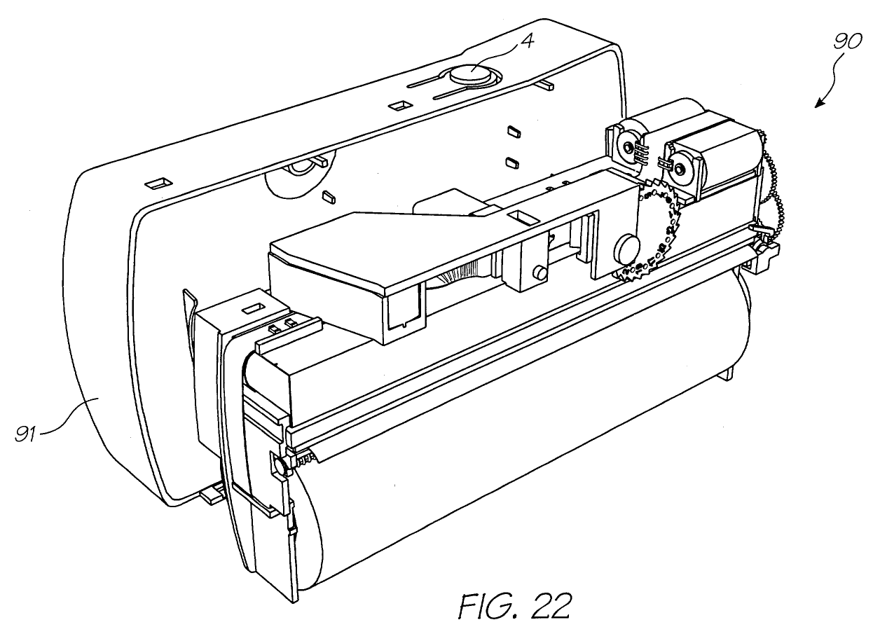

Turning next to FIG. 22, the assembled unit 90 is then inserted into a front outer case 91 which includes button 4 for activation of printouts.

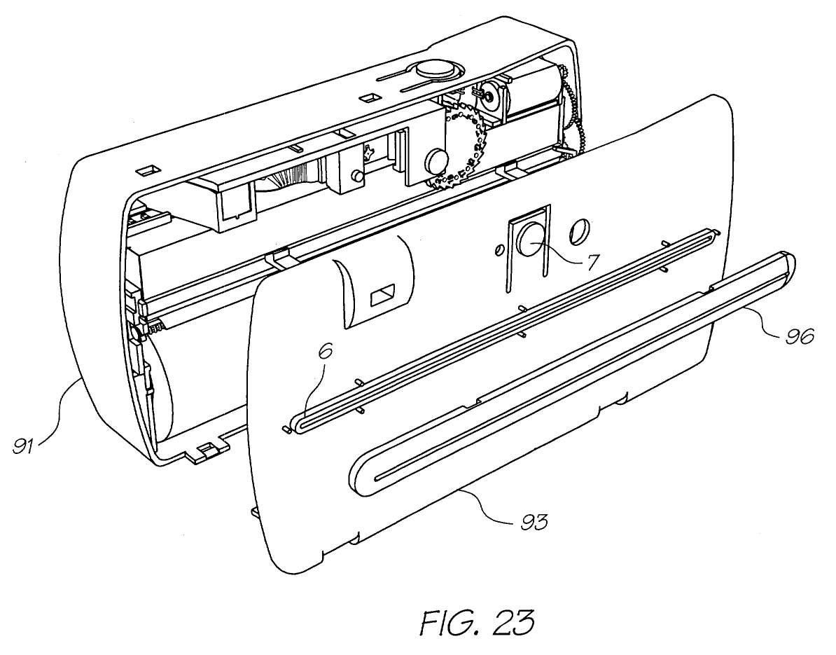

Turning now to FIG. 23, next, the unit 90 is provided with a snap-on back cover 93 which includes a slot 6 and copy print button 7. A wrapper label containing instructions and advertising (not shown) is then wrapped around the outer surface of the camera system and pinch clamped to the cover by means of clamp strip 96 which can comprise a flexible plastic or rubber strip.

Subsequently, the preferred embodiment is ready for use as a one time use camera system that provides for instant output images on demand.

It will be evident that the preferred embodiment further provides for a refillable camera system. A used camera can be collected and its outer plastic cases removed and recycled. A new paper roll and batteries can be added and the ink cartridge refilled. A series of automatic test routines can then be carried out to ensure that the printer is properly operational. Further, in order to ensure only authorised refills are conducted so as to enhance quality, routines in the on-chip program ROM can be executed such that the camera authenticates the refilling station using a secure protocol. Upon authentication, the camera can reset an internal paper count and an external case can be fitted on the camera system with a new outer label. Subsequent packing and shipping can then take place.

It will be further readily evident to those skilled in the art that the program ROM can be modified so as to allow for a variety of digital processing routines. In addition to the digitally enhanced photographs optimised for mainstream consumer preferences, various other models can readily be provided through mere re-programming of the program ROM. For example, a sepia classic old fashion style output can be provided through a remapping of the colour mapping function. A further alternative is to provide for black and white outputs again through a suitable colour remapping algorithm. Minimum colour can also be provided to add a touch of colour to black and white prints to produce the effect that was traditionally used to colourize black and white photos. Further, passport photo output can be provided through suitable address remappings within the address generators. Further, edge filters can be utilised as is known in the field of image processing to produce sketched art styles. Further, classic wedding borders and designs can be placed around an output image in addition to the provision of relevant clip arts. For example, a wedding style camera might be provided. Further, a panoramic mode can be provided so as to output the well known panoramic format of images. Further, a postcard style output can be provided through the printing of postcards including postage on the back of a print roll surface. Further, cliparts can be provided for special events such as Halloween, Christmas etc. Further, kaleidoscopic effects can be provided through address remappings and wild colour effects can be provided through remapping of the colour lookup table. Many other forms of special event cameras can be provided for example, cameras dedicated to the Olympics, movie tie-ins, advertising and other special events.

The operational mode of the camera can be programmed so that upon the depressing of the take photo a first image is sampled by the sensor array to determine irrelevant parameters. Next a second image is again captured which is utilised for the output. The captured image is then manipulated in accordance with any special requirements before being initially output on the paper roll. The LED light is then activated for a predetermined time during which the DRAM is refreshed so as to retain the image. If the print copy button is depressed during this predetermined time interval, a further copy of the photo is output. After the predetermined time interval where no use of the camera has occurred, the onboard CPU shuts down all power to the camera system until such time as the take button is again activated. In this way, substantial power savings can be realized.

Ink Jet Technologies

The embodiments of the invention use an ink jet printer type device. Of course many different devices could be used. However presently popular ink jet printing technologies are unlikely to be suitable.

The most significant problem with thermal ink jet is power consumption. This is approximately 100 times that required for high speed, and stems from the energy-inefficient means of drop ejection. This involves the rapid boiling of water to produce a vapor bubble which expels the ink. Water has a very high heat capacity, and must be superheated in thermal ink jet applications. This leads to an efficiency of around 0.02%, from electricity input to drop momentum (and increased surface area) out.

The most significant problem with piezoelectric ink jet is size and cost. Piezoelectric crystals have a very small deflection at reasonable drive voltages, and therefore require a large area for each nozzle. Also, each piezoelectric actuator must be connected to its drive circuit on a separate substrate. This is not a significant problem at the current limit of around 300 nozzles per printhead, but is a major impediment to the fabrication of pagewidth printheads with 19,200 nozzles.

Ideally, the ink jet technologies used meet the stringent requirements of in-camera digital color printing and other high quality, high speed, low cost printing applications. To meet the requirements of digital photography, new ink jet technologies have been created. The target features include:

low power (less than 10 Watts)

high resolution capability (1,600 dpi or more)

photographic quality output

low manufacturing cost

small size (pagewidth times minimum cross section)

high speed (<2 seconds per page).

All of these features can be met or exceeded by the ink jet systems described below with differing levels of difficulty. Forty five different ink jet technologies have been developed by the Assignee to give a wide range of choices for high volume manufacture. These technologies form part of separate applications assigned to the present Assignee as set out in the table under the heading CROSS REFERENCES TO RELATED APPLICATIONS.

The ink jet designs shown here are suitable for a wide range of digital printing systems, from battery powered one-time use digital cameras, through to desktop and network printers, and through to commercial printing systems

For ease of manufacture using standard process equipment, the printhead is designed to be a monolithic 0.5 micron CMOS chip with MEMS post processing. For color photographic applications, the printhead is 100 mm long, with a width which depends upon the ink jet type. The smallest print head designed is IJ38, which is 0.35 mm wide, giving a chip area of 35 square mm. The printheads each contain 19,200 nozzles plus data and control circuitry.

Ink is supplied to the back of the printhead by injection molded plastic ink channels. The molding requires 50 micron features, which can be created using a lithographically micromachined insert in a standard injection molding tool. Ink flows through holes etched through the wafer to the nozzle chambers fabricated on the front surface of the wafer. The printhead is connected to the camera circuitry by tape automated bonding.

Tables of Drop-On-Demand Ink Jets

Eleven important characteristics of the fundamental operation of individual ink jet nozzles have been identified. These characteristics are largely orthogonal, and so can be elucidated as an eleven dimensional matrix. Most of the eleven axes of this matrix include entries developed by the present assignee.

The following tables form the axes of an eleven dimensional table of ink jet types.

Actuator mechanism (18 types)

Basic operation mode (7 types)

Auxiliary mechanism (8 types)

Actuator amplification or modification method (17 types)

Actuator motion (19 types)

Nozzle refill method (4 types)

Method of restricting back-flow through inlet (10 types)

Nozzle clearing method (9 types)

Nozzle plate construction (9 types)

Drop ejection direction (5 types)

Ink type (7 types)

The complete eleven dimensional table represented by these axes contains 36.9 billion possible configurations of ink jet nozzle. While not all of the possible combinations result in a viable ink jet technology, many million configurations are viable. It is clearly impractical to elucidate all of the possible configurations. Instead, certain ink jet types have been investigated in detail. These are designated IJ01 to IJ45 above which match the docket numbers in the table under the heading Cross References to Related Applications.

Other ink jet configurations can readily be derived from these forty-five examples by substituting alternative configurations along one or more of the 11 axes. Most of the IJ01 to IJ45 examples can be made into ink jet print heads with characteristics superior to any currently available ink jet technology.

Where there are prior art examples known to the inventor, one or more of these examples are listed in the examples column of the tables below. The IJ01 to IJ45 series are also listed in the examples column. In some cases, a print technology may be listed more than once in a table, where it shares characteristics with more than one entry.

Suitable applications for the ink jet technologies include: Home printers, Office network printers, Short run digital printers, Commercial print systems, Fabric printers, Pocket printers, Internet WWW printers, Video printers, Medical imaging, Wide format printers, Notebook PC printers, Fax machines, Industrial printing systems, Photocopiers, Photographic minilabs etc.

The information associated with the aforementioned 11 dimensional matrix are set out in the following tables.

| | | | |
|---|---|---|---|
| Description | Advantages | Disadvantages | Examples |

ACTUATOR MECHANISM
(APPLIED ONLY TO SELECTED INK DROPS)

| | | | | |
|---|---|---|---|---|
| Thermal | An | Large force | High power | Canon |
| bubble | electrothermal | generated | Ink carrier | Bubblejet |
| | heater heats | Simple | limited to | 1979 Endo et |
| | the ink to | construction | water | al GB patent |
| | above boiling | No moving | Low | 2,007,162 |
| | point, | parts | efficiency | Xerox |
| | transferring | Fast | High | heater-in- |
| | significant | operation | temperatures | pit 1990 |
| | heat to the | Small chip | required | Hawkins |
| | aqueous ink. | area required | High | et al USP |
| | A bubble | for actuator | mechanical | 4,899,181 |
| | nucleates and | | stress | Hewlett- |
| | quickly forms, | | Unusual | Packard TIJ |
| | expelling the | | materials | 1982 Vaught |
| | ink. | | required | et al USP |
| | The efficiency | | Large drive | 4,490,728 |
| | of the process | | transistors | |
| | is low, with | | Cavitation | |
| | typically less | | causes | |
| | than 0.05% of | | actuator | |
| | the electrical | | failure | |
| | energy being | | Kogation | |
| | transformed | | reduces | |
| | into kinetic | | bubble | |
| | energy of the | | formation | |
| | drop. | | Large print | |
| | | | heads are | |
| | | | difficult to | |
| | | | fabricate | |
| Piezo- | A piezoelectric | Low power | Very large | Kyser et al |
| electric | crystal such as | consumption | area required | USP |
| | lead lanthanum | Many ink | for actuator | 3,946,398 |
| | zirconate (PZT) | types can be | Difficult to | Zoltan USP |
| | is electrically | used | integrate | 3,683,212 |
| | activated, and | Fast | with | 1973 |
| | either expands, | operation | electronics | Stemme |
| | shears, or | High | High voltage | USP |
| | bends to apply | efficiency | drive | 3,747,120 |
| | pressure to the | | transistors | Epson Stylus |
| | ink, ejecting | | required | Tektronix |
| | drops. | | Full | IJ04 |
| | | | pagewidth | |
| | | | print heads | |
| | | | impractical | |
| | | | due to | |
| | | | actuator size | |
| | | | Requires | |
| | | | electrical | |
| | | | poling in | |
| | | | high field | |
| | | | strengths | |
| | | | during | |
| | | | manufacture | |
| Electro- | An electric | Low power | Low maximum | Seiko Epson, |
| strictive | field is used | consumption | strain | Usui et al |
| | to activate | Many ink | (approx. | JP |
| | electrostriction | types can be | 0.01%) | 253401/96 |
| | in relaxor | used | Large area | IJ04 |
| | materials such | Low thermal | required for | |
| | as lead | expansion | actuator due | |
| | lanthanum | Electric | to low strain | |
| | zirconate | field | Response | |
| | titanate (PLZT) | strength | speed is | |
| | or lead | required | marginal | |
| | magnesium | (approx. 3.5 | (˜10 μs) | |
| | niobate (PMN). | V/μm) can | High voltage | |
| | | be generated | drive | |
| | | without | transistors | |
| | | difficulty | required | |
| | | Does not | Full | |
| | | require | pagewadth | |
| | | electrical | print heads | |
| | | poling | impractical | |
| | | | due to | |
| | | | actuator size | |
| Ferro- | An electric | Low power | Difficult to | IJ04 |
| electric | field is used | consumption | integrate | |
| | to induce a | Many ink | with | |
| | phase | types can be | electronics | |
| | transition | used | Unusual | |
| | between the | Fast | materials | |
| | antiferroelectric | operation | such as | |
| | (AFE) and | (<1 μs) | PLZSnT are | |
| | ferroelectric | Relatively | required | |
| | (FE) phase. | high | Actuators | |
| | Perovskite | longitudinal | require a | |
| | materials such | strain | large area | |
| | as tin modified | High | | |
| | lead lanthanum | efficiency | | |
| | zirconate | Electric | | |
| | titanate | field | | |
| | (PLZSnT) | strength of | | |
| | exhibit large | around | | |
| | strains of up | 3 V/μm | | |
| | to 1% | can be | | |
| | associated with | readily | | |
| | the AFE to FE | provided | | |
| | phase | | | |
| | transition. | | | |
| Electro- | Conductive | Low power | Difficult to | IJ02, IJ04 |
| static | plates are | consumption | operate | |
| plates | separated by a | Many ink | electrostatic | |
| | compressible or | types can be | devices in an | |
| | fluid | used | aqueous | |
| | dielectric | Fast | environment | |
| | (usually air). | operation | The | |
| | Upon | | electrostatic | |
| | application of | | actuator will | |
| | a voltage, the | | normally need | |
| | plates attract | | to be | |
| | each other and | | separated | |
| | displace ink, | | from the ink | |
| | causing drop | | Very large | |
| | ejection. The | | area required | |
| | conductive | | to achieve | |
| | plates may be | | high forces | |
| | in a comb or | | High voltage | |
| | honeycomb | | drive | |
| | structure, or | | transistors | |
| | stacked to | | may be | |
| | increase the | | required | |
| | surface area | | Full | |
| | and therefore | | pagewidth | |
| | the force. | | print heads | |
| | | | are not | |
| | | | competitive | |
| | | | due to | |
| | | | actuator size | |
| Electro- | A strong | Low current | High voltage | 1989 Saito et |
| static | electric field | consumption | required | al, USP |
| pull on | is applied to | Low | May be | 4,799,068 |
| ink | the ink, | temperature | damaged by | 1989 Miura |
| | whereupon | | sparks due to | et al, USP |
| | electrostatic | | air breakdown | 4,810,954 |
| | attraction | | Required | Tone-jet |
| | accelerates the | | field | |
| | ink towards the | | strength | |
| | print medium. | | increases as | |
| | | | the drop size | |
| | | | decreases | |
| | | | High voltage | |
| | | | drive | |
| | | | transistors | |
| | | | required | |
| | | | Electrostatic | |
| | | | field | |
| | | | attracts dust | |
| Permanent | An | Low power | Complex | IJ07, IJ10 |
| magnet | electromagnet | consumption | fabrication | |
| electro- | directly | Many ink | Permanent | |
| magnetic | attracts a | types can be | magnetic | |
| | permanent | used | material such | |
| | magnet, | Fast | as Neodymium | |
| | displacing ink | operation | Iron Boron | |
| | and causing | High | (NdFeB) | |
| | drop ejection. | efficiency | required. | |
| | Rare earth | Easy | High local | |
| | magnets with a | extension | currents | |
| | field strength | from single | required | |
| | around 1 Tesla | nozzles to | Copper | |
| | can be used. | pagewidth | metalization | |
| | Examples are: | print heads | should be | |
| | Samarium | | used for long | |
| | Cobalt (SaCo) | | electro- | |
| | and magnetic | | migration | |
| | materials in | | lifetime | |
| | the neodymium | | and low | |
| | iron boron | | resistivity | |
| | family (NdFeB, | | Pigmented | |
| | NdDyFeBNb, | | inks are | |
| | NdDyFeB, etc) | | usually | |
| | | | infeasible | |
| | | | Operating | |
| | | | temperature | |
| | | | limited to | |
| | | | the Curie | |
| | | | temperature | |
| | | | (around 540 K) | |
| Soft | A solenoid | Low power | Complex | IJ01, IJ05, |
| magnetic | induced a | consumption | fabrication | IJ08, IJ10, |
| core | magnetic field | Many ink | Materials not | IJ12, IJ14, |
| electro- | in a soft | types can be | usually | IJ15, IJ17 |
| magnetic | magnetic core | used | present in | |
| | or yoke | Fast | a CMOS fab | |
| | fabricated from | operation | such as NiFe, | |
| | a ferrous | High | CoNiFe, or | |
| | material such | efficiency | CoFe are | |
| | as electroplated | Easy | required | |
| | iron alloys | extension | High local | |
| | such as CoNiFe | from single | currents | |
| | [1], CoFe, or | nozzles to | required | |
| | NiFe alloys. | pagewidth | Copper | |
| | Typically, the | print heads | metalization | |
| | soft magnetic | | should be | |
| | material is in | | used for long | |
| | two parts, | | electro- | |
| | which are | | migration | |
| | normally held | | lifetime and | |
| | apart by a | | low resistivity | |
| | spring. When | | Electroplating | |
| | the solenoid is | | is required | |
| | actuated, the | | High | |
| | two parts | | saturation | |
| | attract, | | flux density | |
| | displacing the | | is required | |
| | ink. | | (2.0-2.1 T is | |
| | | | achievable | |
| | | | with CoNiFe | |
| | | | [1]) | |
| Lorenz | The Lorenz | Low power | Force acts as | IJ06, IJ11, |
| force | force acting on | consumption | a twisting | IJ13, IJ16 |
| | a current | Many ink | motion | |
| | carrying wire | types can be | Typically, | |
| | in a magnetic | used | only a | |
| | field is | Fast | quarter of | |
| | utilized. | operation | the solenoid | |
| | This allows the | High | length | |
| | magnetic field | efficiency | provides | |
| | to be supplied | Easy | force in a | |
| | externally to | extension | useful | |
| | the print head, | from single | direction | |
| | for example | nozzles to | High local | |
| | with rare earth | pagewidth | currents | |
| | permanent | print heads | required | |
| | magnets. | | Copper | |
| | Only the | | metalization | |
| | current | | should be | |
| | carrying wire | | used for long | |
| | need be | | electro- | |
| | fabricated on | | migration | |
| | the print-head, | | lifetime | |
| | simplifying | | and low | |
| | materials | | resistivity | |
| | requirements. | | Pigmented | |
| | | | inks are | |
| | | | usually | |
| | | | infeasible | |
| Magneto- | The actuator | Many ink | Force acts as | Fischenbeck, |
| striction | uses the giant | types can be | a twisting | USP |
| | magneto- | used | motion | 4,032,929 |
| | strictive effect | Fast | Unusual | IJ25 |
| | of materials | operation | materials | |
| | such as | Easy | such as | |
| | Terfenol-D (an | extension | Terfenol-D | |
| | alloy of | from single | are required | |
| | terbium, | nozzles to | High local | |
| | dysprosium and | pagewidth | currents | |
| | iron developed | print heads | required | |
| | at the Naval | High force is | Copper | |
| | Ordnance | available | metalization | |
| | Laboratory, | | should be | |
| | hence Ter-Fe- | | used for long | |
| | NOL). For best | | electro- | |
| | efficiency, the | | migration | |
| | actuator should | | lifetime | |
| | be pre-stressed | | and low | |
| | to approx. 8 | | resistivity | |
| | MPa. | | Pre-stressing | |
| | | | may be | |
| | | | required | |
| Surface | Ink under | Low power | Requires | Silverbrook, |
| tension | positive | consumption | supplementary | EP 0771 658 |
| reduction | pressure is | Simple | force to | A2 and |
| | held in a | construction | effect drop | related |
| | nozzle by | No unusual | separation | patent |
| | surface | materials | Requires | applications |
| | tension. The | required in | special ink | |
| | surface tension | fabrication | surfactants | |
| | of the ink is | High | Speed may be | |
| | reduced below | efficiency | limited by | |
| | the bubble | Easy | surfactant | |
| | threshold, | extension | properties | |
| | causing the ink | from single | | |
| | to egress from | nozzles to | | |
| | the nozzle. | pagewidth | | |
| | | print heads | | |
| Viscosity | The ink | Simple | Requires | Silverbrook, |
| reduction | viscosity is | construction | supplementary | EP 0771 658 |
| | locally reduced | No unusual | force to | A2 and |
| | to select which | materials | effect drop | related |
| | drops are to be | required in | separation | patent |
| | ejected. A | fabrication | Requires | applications |
| | viscosity | Easy | special ink | |
| | reduction can | extension | viscosity | |
| | be achieved | from single | properties | |
| | electro- | nozzles to | High speed is | |
| | thermally with | pagewidth | difficult to | |
| | most inks, but | print heads | achieve | |
| | special inks | | Requires | |
| | can be | | oscillating | |
| | engineered for | | ink pressure | |
| | a 100:1 | | A high | |
| | viscosity | | temperature | |
| | reduction. | | difference | |
| | | | (typically 80 | |
| | | | degrees) is | |
| | | | required | |
| Acoustic | An acoustic | Can operate | Complex drive | 1993 |
| | wave is | without a | circuitry | Hadimioglu |
| | generated and | nozzle plate | Complex | et al, EUP |
| | focussed upon | | fabrication | 550,192 |
| | the drop | | Low | 1993 Elrod |
| | ejection | | efficiency | et al, EUP |
| | region. | | Poor control | 572,220 |
| | | | of drop | |
| | | | position | |
| | | | Poor control | |
| | | | of drop | |
| | | | volume | |
| Thermo- | An actuator | Low power | Efficient | IJ03, IJ09, |
| elastic | which relies | consumption | aqueous | IJ17, IJ18, |
| bend | upon | Many ink | operation | IJ19, IJ20, |
| actuator | differential | types can be | requires a | IJ21, IJ22, |
| | thermal | used | thermal | IJ23, IJ24, |
| | expansion upon | Simple | insulator on | IJ27, IJ28, |
| | Joule heating | planar | the hot side | IJ29, IJ30, |
| | is used. | fabrication | Corrosion | IJ31, IJ32, |
| | | Small chip | prevention | IJ33, IJ34, |
| | | area required | can be | IJ35, IJ36, |
| | | for each | difficult | IJ37, IJ38, |
| | | actuator | Pigmented | IJ39, IJ40, |
| | | Fast | inks may be | IJ41 |
| | | operation | infeasible, | |
| | | High | as pigment | |
| | | efficiency | particles may | |
| | | CMOS | jam the bend | |
| | | compatible | actuator | |
| | | voltages and | | |
| | | currents | | |
| | | Standard | | |
| | | MEMS | | |
| | | processes | | |
| | | can be used | | |
| | | Easy | | |
| | | extension | | |
| | | from single | | |
| | | nozzles to | | |
| | | pagewidth | | |
| | | print heads | | |
| High CTE | A material with | High force | Requires | IJ09, IJ17, |
| thermo- | a very high | can be | special | IJ18, IJ20, |
| elastic | coefficient of | generated | material | IJ21, IJ22, |
| actuator | thermal | Three | (e.g. PTFE) | IJ23, IJ24, |
| | expansion | methods | Requires a | IJ27, IJ28, |
| | (CTE) such as | of PTFE | PTFE | IJ29, IJ30, |
| | polytetrafluoro | deposition | deposition | IJ31, IJ42, |
| | ethylene | are under | process, | IJ43, IJ44 |
| | (PTFE) is used. | develop- | which is not | |
| | As high CTE | ment: | yet standard | |
| | materials are | chemical | in ULSI fabs | |
| | usually non- | vapor | PTFE | |
| | conductive, a | deposition | deposition | |
| | heater | (CVD), spin | cannot be | |
| | fabricated from | coating, and | followed | |
| | a conductive | evaporation | with high | |
| | material is | PTFE is a | temperature | |
| | incorporated. A | candidate | (above | |
| | 50 μm long | for low | 350° C.) | |
| | PTFE bend | dielectric | processing | |
| | actuator with | constant | Pigmented | |
| | polysilicon | insulation in | inks may be | |
| | heater and 15 | ULSI | infeasible, | |
| | mW power | Very low | as pigment | |
| | input can | power | particles may | |
| | provide 180 μN | consumption | jam the bend | |
| | force and 10 | Many ink | actuator | |
| | μm deflection. | types can be | | |
| | Actuator | used | | |
| | motions | Simple | | |
| | include: | planar | | |
| | Bend | fabrication | | |
| | Push | Small chip | | |
| | Buckle | area required | | |
| | Rotate | for each | | |
| | | actuator | | |
| | | Fast | | |
| | | operation | | |
| | | High | | |
| | | efficiency | | |
| | | CMOS | | |
| | | compatible | | |
| | | voltages and | | |
| | | currents | | |
| | | Easy | | |
| | | extension | | |
| | | from single | | |
| | | nozzles to | | |
| | | pagewidth | | |
| | | print heads | | |
| Con- | A polymer with | High force | Requires | IJ24 |
| ductive | a high | can be | special | |
| polymer | coefficient of | generated | materials | |
| thermo- | thermal | Very low | development | |
| elastic | expansion | power | (High CTE | |
| actuator | (such as PTFE) | consumption | conductive | |
| | is doped with | Many ink | polymer) | |
| | conducting | types can be | Requires a | |
| | substances to | used | PTFE | |
| | increase its | Simple | deposition | |
| | conductivity to | planar | process, | |
| | about 3 orders | fabrication | which is not | |
| | of magnitude | Small chip | yet standard | |
| | below that of | area required | in ULSI fabs | |
| | copper. The | for each | PTFE | |
| | conducting | actuator | deposition | |
| | polymer | Fast | cannot be | |
| | expands when | operation | followed with | |
| | resistively | High | high | |
| | heated. | efficiency | temperature | |
| | Examples of | CMOS | (above | |
| | conducting | compatible | 350° C.) | |
| | dopants | voltages and | processing | |
| | include: | currents | Evaporation | |
| | Carbon | Easy | and CVD | |
| | nanotubes | extension | deposition | |
| | Metal fibers | from single | techniques | |
| | Conductive | nozzles to | cannot be | |
| | polymers such | pagewidth | used | |
| | as doped | print heads | Pigmented | |
| | polythiophene | | inks may be | |
| | Carbon | | infeasible, | |
| | granules | | as pigment | |
| | | | particles may | |
| | | | jam the bend | |
| | | | actuator | |
| Shape | A shape | High force | Fatigue | IJ26 |
| memory | memory alloy | is available | limits | |
| alloy | such as TiNi | (stresses of | maximum | |
| | (also known as | hundreds of | number of | |
| | Nitinol-Nickel | MPa) | cycles | |
| | Titanium alloy | Large strain | Low strain | |
| | developed | is available | (1%) is | |
| | at the Naval | (more than | required to | |
| | Ordnance | 3%) | extend | |
| | Laboratory) is | High | fatigue | |
| | thermally | corrosion | resistance | |
| | switched | resistance | Cycle rate | |
| | between its | Simple | limited by | |
| | weak | construction | heat removal | |
| | martensitic | Easy | Requires | |
| | state and its | extension | unusual | |
| | high stiffness | from single | materials | |
| | austenic state. | nozzles to | (TiNi) | |
| | The shape of | pagewidth | The latent | |
| | the actuator in | print heads | heat of | |
| | its martensitic | Low voltage | trans- | |
| | state is | operation | formation | |
| | deformed | | must be | |
| | relative to the | | provided | |
| | austenic shape. | | High current | |
| | The shape | | operation | |
| | change causes | | Requires pre- | |
| | ejection of a | | stressing to | |
| | drop. | | distort the | |
| | | | martensitic | |
| | | | state | |
| Linear | Linear | Linear | Requires | IJ12 |
| Magnetic | magnetic | Magnetic | unusual | |
| Actuator | actuators | actuators | semiconductor | |
| | include the | can be | materials | |
| | Linear | constructed | such as soft | |
| | Induction | with high | magnetic | |
| | Actuator (LIA), | thrust, long | alloys (e.g. | |
| | Linear | travel, and | CoNiFe) | |
| | Permanent | high | Some | |
| | Magnet | efficiency | varieties | |
| | Synchronous | using planar | also require | |
| | Actuator | semi- | permanent | |
| | (LPMSA), | conductor | magnetic | |
| | Linear | fabrication | materials | |
| | Reluctance | techniques | such as | |
| | Synchronous | Long | Neodymium | |
| | Actuator | actuator | iron boron | |
| | (LRSA), Linear | travel is | (NdFeB) | |
| | Switched | available | Requires | |
| | Reluctance | Medium | complex | |
| | Actuator | force is | multi-phase | |
| | (LSRA), and | available | drive | |
| | the Linear | Low voltage | circuitry | |
| | Stepper | operation | High current | |
| | Actuator | | operation | |
| | (LSA). | | | |

BASIC OPERATION MODE

| | | | | |
|---|---|---|---|---|
| Actuator | This is the | Simple | Drop | Thermal |
| directly | simplest mode | operation | repetition | ink jet |
| pushes | of operation: | No external | rate is | Piezoelectric |
| ink | the actuator | fields | usually | ink jet |
| | directly | required | limited to | IJ01, IJ02, |
| | supplies | Satellite | around 10 | IJ03, IJ04, |
| | sufficient | drops can be | kHz. However, | IJ05, IJ06, |
| | kinetic energy | avoided if | this is not | IJ07, IJ09, |
| | to expel the | drop velocity | fundamental | IJ11, IJ12, |
| | drop. The drop | is less than | to the | IJ14, IJ16, |
| | must have a | 4 m/s | method, but | IJ20, IJ22, |
| | sufficient | Can be | is related to | IJ23, IJ24, |
| | velocity to | efficient, | the refill | IJ25, IJ26, |
| | overcome the | depending | method | IJ27, IJ28, |
| | surface | upon the | normally used | IJ29, IJ30, |
| | tension. | actuator used | All of the | IJ31, IJ32, |
| | | | drop kinetic | IJ33, IJ34, |
| | | | energy must | IJ35, IJ36, |
| | | | be provided | IJ37, IJ38, |
| | | | by the | IJ39, IJ40, |
| | | | actuator | IJ41, IJ42, |
| | | | Satellite | IJ43, IJ44 |
| | | | drops usually | |
| | | | form if drop | |
| | | | velocity is | |
| | | | greater than | |
| | | | 4.5 m/s | |
| Proximity | The drops to be | Very simple | Requires | Silverbrook, |
| | printed are | print head | close | EP 0771 658 |
| | selected by | fabrication | proximity | A2 and |
| | some manner | can be used | between the | related |
| | (e.g. thermally | The drop | print head | patent |
| | induced surface | selection | and the print | applications |
| | tension | means does | media or | |
| | reduction of | not need to | transfer | |
| | pressurized | provide the | roller | |
| | ink). Selected | energy | May require | |
| | drops are | required to | two print | |
| | separated from | separate the | heads | |
| | the ink in the | drop from | printing | |
| | nozzle by | the nozzle | alternate | |
| | contact with | | rows of the | |
| | the print | | image | |
| | medium or a | | Monolithic | |
| | transfer | | color print | |
| | roller. | | heads are | |
| | | | difficult | |
| Electro- | The drops to be | Very simple | Requires | Silverbrook, |
| static | printed are | print head | very high | EP 0771 658 |
| pull on | selected by | fabrication | electrostatic | A2 and |
| ink | some manner | can be used | field | related |
| | (e.g. thermally | The drop | Electrostatic | patent |
| | induced surface | selection | field for | applications |
| | tension | means does | small nozzle | Tone-Jet |
| | reduction of | not need to | sizes is | |
| | pressurized | provide the | above air | |
| | ink). Selected | energy | breakdown | |
| | drops are | required to | Electrostatic | |
| | separated from | separate the | field may | |
| | the ink in the | drop from | attract dust | |
| | nozzle by a | the nozzle | | |
| | strong electric | | | |
| | field. | | | |
| Magnetic | The drops to be | Very simple | Requires | Silverbrook, |
| pull on | printed are | print head | magnetic ink | EP 0771 658 |
| ink | selected by | fabrication | Ink colors | A2 and |
| | some manner | can be used | other than | related |
| | (e.g. thermally | The drop | black are | patent |
| | induced surface | selection | difficult | applications |
| | tension | means does | Requires very | |
| | reduction of | not need to | high magnetic | |
| | pressurized | provide the | fields | |
| | ink). Selected | energy | | |
| | drops are | required to | | |
| | separated from | separate the | | |
| | the ink in the | drop from | | |
| | nozzle by a | the nozzle | | |
| | strong | | | |
| | magnetic | | | |
| | field acting on | | | |
| | the magnetic | | | |
| | ink. | | | |
| Shutter | The actuator | High speed | Moving parts | IJ13, IJ17, |
| | moves a shutter | (>50 kHz) | are required | IJ21 |
| | to block ink | operation | Requires ink | |
| | flow to the | can be | pressure | |
| | nozzle. The ink | achieved due | modulator | |
| | pressure is | to reduced | Friction and | |
| | pulsed at a | refill time | wear must be | |
| | multiple of the | Drop timing | considered | |
| | drop ejection | can be very | Stiction is | |
| | frequency. | accurate | possible | |
| | | The actuator | | |
| | | energy can | | |
| | | be very low | | |
| Shuttered | The actuator | Actuators | Moving parts | IJ08, IJ15, |
| grill | moves a shutter | with small | are required | IJ18, IJ19 |
| | to block ink | travel can | Requires ink | |
| | flow through a | be used | pressure | |
| | grill to the | Actuators | modulator | |
| | nozzle. The | with small | Friction and | |
| | shutter | force can | wear must be | |
| | movement need | be used | considered | |
| | only be equal | High speed | Stiction is | |
| | to the width | (>50 kHz) | possible | |
| | of the grill | operation | | |
| | holes. | can be | | |
| | | achieved | | |
| Pulsed | A pulsed | Extremely | Requires an | IJ10 |
| magnetic | magnetic field | low energy | external | |
| pull on | attracts an | operation is | pulsed | |
| ink | ‘ink pusher’ | possible | magnetic | |
| pusher | at the drop | No heat | field | |
| | ejection | dissipation | Requires | |
| | frequency. An | problems | special | |
| | actuator | | materials for | |
| | controls a | | both the | |
| | catch, which | | actuator and | |
| | prevents the | | the ink | |
| | ink pusher | | pusher | |
| | from moving | | Complex | |
| | when a drop is | | construction | |
| | not to be | | | |
| | ejected. | | | |

AUXILIARY MECHANISM (APPLIED TO ALL NOZZLES)

| | | | | |
|---|---|---|---|---|
| None | The actuator | Simplicity of | Drop ejection | Most ink |
| | directly fires | construction | energy must | jets, |
| | the ink drop, | Simplicity of | be supplied | including |
| | and there is no | operation | by individual | piezoelectric |
| | external field | Small | nozzle | and thermal |
| | or other | physical size | actuator | bubble. |
| | mechanism | | | IJ01, IJ02, |
| | required. | | | IJ03, IJ04, |
| | | | | IJ05, IJ07, |
| | | | | IJ09, IJ11, |
| | | | | IJ12, IJ14, |
| | | | | IJ20, IJ22, |
| | | | | IJ23, IJ24, |
| | | | | IJ25, IJ26, |
| | | | | IJ27, IJ28, |
| | | | | IJ29, IJ30, |
| | | | | IJ31, IJ32, |
| | | | | IJ33, IJ34, |
| | | | | IJ35, IJ36, |
| | | | | IJ37, IJ38, |
| | | | | IJ39, IJ40, |
| | | | | IJ41, IJ42, |
| | | | | IJ43, IJ44 |
| Oscillating | The ink | Oscillating | Requires | Silverbrook, |
| ink | pressure | ink pressure | external ink | EP 0771 658 |
| pressure | oscillates, | can provide | pressure | A2 and |
| (including | providing much | a refill pulse, | oscillator | related |
| acoustic | of the drop | allowing | Ink pressure | patent |
| stimu- | ejection | higher | phase and | applications |
| lation) | energy. The | operating | amplitude | IJ08, IJ13, |
| | actuator | speed | must be | IJ15, IJ17, |
| | selects which | The | carefully | IJ18, IJ19, |
| | drops are to | actuators | controlled | IJ21 |
| | be fired by | may operate | Acoustic | |
| | selectively | with much | reflections | |
| | blocking or | lower energy | in the ink | |
| | enabling | Acoustic | chamber must | |
| | nozzles. The | lenses can be | be designed | |
| | ink pressure | used to focus | for | |
| | oscillation may | the sound on | | |
| | be achieved by | the nozzles | | |
| | vibrating the | | | |
| | print head, or | | | |
| | preferably by | | | |
| | an actuator in | | | |
| | the ink supply. | | | |
| Media | The print head | Low power | Precision | Silverbrook, |
| proximity | is placed in | High | assembly | EP 0771 658 |
| | close proximity | accuracy | required | A2 and |
| | to the print | Simple | Paper fibers | related |
| | medium. | print head | may cause | patent |
| | Selected drops | construction | problems | applications |
| | protrude from | | Cannot print | |
| | the print head | | on rough | |
| | further than | | substrates | |
| | unselected | | | |
| | drops, and | | | |
| | contact the | | | |
| | print medium. | | | |
| | The drop soaks | | | |
| | into the | | | |
| | medium fast | | | |
| | enough to | | | |
| | cause drop | | | |
| | separation. | | | |
| Transfer | Drops are | High | Bulky | Silverbrook, |
| roller | printed to a | accuracy | Expensive | EP 0771 658 |
| | transfer roller | Wide range | complex | A2 and |
| | instead of | of print | construction | related |
| | straight to the | substrates | | patent |
| | print medium. | can be used | | applications |
| | A transfer | Ink can be | | Tektronix |
| | roller can also | dried on the | | hot melt |
| | be used for | transfer | | piezoelectric |
| | proximity drop | roller | | ink jet |
| | separation. | | | Any of the IJ |
| | | | | series |
| Electro- | An electric | Low power | Field | Silverbrook, |
| static | field is used | Simple | strength | EP 0771 658 |
| | to accelerate | print head | required for | A2 and |
| | selected drops | construction | separation of | related |
| | towards the | | small drops | patent |
| | print medium. | | is near or | applications |
| | | | above air | Tone-Jet |
| | | | breakdown | |
| Direct | A magnetic | Low power | Requires | Silverbrook, |
| magnetic | field is used | Simple | magnetic ink | EP 0771 658 |
| field | to accelerate | print head | Requires | A2 and |
| | selected drops | construction | strong | related |
| | of magnetic ink | | magnetic | patent |
| | towards the | | field | applications |
| | print medium. | | | |
| Cross | The print head | Does not | Requires | IJ06, IJ16 |
| magnetic | is placed in a | require | external | |
| field | constant | magnetic | magnet | |
| | magnetic field. | materials to | Current | |
| | The Lorenz | be integrated | densities may | |
| | force in a | in the print | be high, | |
| | current | head manu- | resulting in | |
| | carrying wire | facturing | electro- | |
| | is used to move | process | migration | |
| | the actuator. | | problems | |
| Pulsed | A pulsed | Very low | Complex | IJ10 |
| magnetic | magnetic field | power | print head | |
| field | is used to | operation is | construction | |
| | cyclically | possible | Magnetic | |
| | attract a | Small print | materials | |
| | paddle, which | head size | required in | |
| | pushes on the | | print head | |
| | ink. A small | | | |
| | actuator moves | | | |
| | a catch, which | | | |
| | selectively | | | |
| | prevents the | | | |
| | paddle from | | | |
| | moving. | | | |

ACTUATOR AMPLIFICATION OR MODIFICATION METHOD

| | | | | |
|---|---|---|---|---|
| None | No actuator | Operational | Many actuator | Thermal |
| | mechanical | simplicity | mechanisms | Bubble Ink |
| | amplification | | have | jet |
| | is used. The | | insufficient | IJ01, IJ02, |
| | actuator | | travel, or | IJ16, IJ25, |
| | directly drives | | insufficient | IJ26 |
| | the drop | | force, to | |
| | ejection | | efficiently | |
| | process. | | drive the | |
| | | | drop ejection | |
| | | | process | |
| Differ- | An actuator | Provides | High stresses | Piezoelectric |
| ential | material | greater | are involved | IJ03, IJ09, |
| expansion | expands more | travel in a | Care must be | IJ17, IJ18, |
| bend | on one side | reduced print | taken that | 1J19, IJ20, |
| actuator | than on the | head area | the materials | IJ21, IJ22, |
| | other. The | | do not | IJ23, IJ24, |
| | expansion may | | delaminate | IJ27, IJ29, |
| | be thermal, | | Residual bend | IJ30, IJ31, |
| | piezoelectric, | | resulting | IJ32, IJ33, |
| | magneto- | | from high | IJ34, IJ35, |
| | strictive, | | temperature | IJ36, IJ37, |
| | or other | | or high | IJ38, IJ39, |
| | mechanism. | | stress during | IJ42, IJ43, |
| | The bend | | formation | IJ44 |
| | actuator | | | |
| | converts a high | | | |
| | force low | | | |
| | travel actuator | | | |
| | mechanism to | | | |
| | high travel, | | | |
| | lower force | | | |
| | mechanism. | | | |
| Transient | A trilayer bend | Very good | High stresses | IJ40, IJ41 |
| bend | actuator where | temperature | are involved | |
| actuator | the two outside | stability | Care must be | |
| | layers are | High speed, | taken that | |
| | identical. This | as a new | the materials | |
| | cancels bend | drop can | do not | |
| | due to ambient | be fired | delaminate | |
| | temperature | before heat | | |
| | and residual | dissipates | | |
| | stress. The | Cancels | | |
| | actuator only | residual | | |
| | responds to | stress of | | |
| | transient | formation | | |
| | heating of one | | | |
| | side or the | | | |
| | other. | | | |
| Reverse | The actuator | Better | Fabrication | IJ05, IJ11 |
| spring | loads a spring. | coupling to | complexity | |
| | When the | the ink | High stress | |
| | actuator is | | in the spring | |
| | turned off, | | | |
| | the spring | | | |
| | releases. This | | | |
| | can reverse the | | | |
| | force/distance | | | |
| | curve of the | | | |
| | actuator to | | | |
| | make it | | | |
| | compatible | | | |
| | with the | | | |
| | force/time | | | |
| | requirements of | | | |
| | the drop | | | |
| | ejection. | | | |
| Actuator | A series of | Increased | Increased | Some |
| stack | thin actuators | travel | fabrication | piezoelectric |
| | are stacked. | Reduced | complexity | ink jets |
| | This can be | drive | Increased | IJ04 |
| | appropriate | voltage | possibility | |
| | where actuators | | of short | |
| | require high | | circuits due | |
| | electric field | | to pinholes | |
| | strength, such | | | |
| | as electrostatic | | | |
| | and | | | |
| | piezoelectric | | | |
| | actuators. | | | |
| Multiple | Multiple | Increases | Actuator | IJ12, IJ13, |
| actuators | smaller | the force | forces may | IJ18, IJ20, |
| | actuators | available | not add | IJ22, IJ28, |
| | are used | from an | linearly, | IJ42, IJ43 |
| | simultaneously | actuator | reducing | |
| | to move the | Multiple | efficiency | |
| | ink. Each | actuators | | |
| | actuator need | can be | | |
| | provide only a | positioned | | |
| | portion of the | to control | | |
| | force required. | ink flow | | |
| | | accurately | | |
| Linear | A linear spring | Matches low | Requires | IJ15 |
| Spring | is used to | travel | print head | |
| | transform a | actuator with | area for | |
| | motion with | higher travel | the spring | |
| | small travel | requirements | | |
| | and high force | Non-contact | | |
| | into a longer | method of | | |
| | travel, lower | motion | | |
| | force motion. | trans- | | |
| | | formation | | |
| Coiled | A bend | Increases | Generally | IJ17, IJ21, |
| actuator | actuator is | travel | restricted to | IJ34, IJ35 |
| | coiled to | Reduces chip | planar | |
| | provide greater | area | implement- | |
| | travel in a | Planar | ations due | |
| | reduced chip | implement- | to extreme | |
| | area. | ations are | fabrication | |
| | | relatively | difficulty | |
| | | easy to | in other | |
| | | fabricate. | orientations. | |
| Flexure | A bend | Simple | Care must be | IJ10, IJ19, |
| bend | actuator has a | means of | taken not to | IJ33 |
| actuator | small region | increasing | exceed the | |
| | near the fixture | travel of | elastic limit | |
| | point, which | a bend | in the | |
| | flexes much | actuator | flexure area | |
| | more readily | | Stress | |
| | than the | | distribution | |
| | remainder of | | is very | |
| | the actuator. | | uneven | |
| | The actuator | | Difficult to | |
| | flexing is | | accurately | |
| | effectively | | model with | |
| | converted from | | finite | |
| | an even coiling | | element | |
| | to an angular | | analysis | |
| | bend, resulting | | | |
| | in greater | | | |
| | travel of the | | | |
| | actuator tip. | | | |
| Catch | The actuator | Very low | Complex | IJ10 |
| | controls a | actuator | construction | |
| | small catch. | energy | Requires | |
| | The catch | Very small | external | |
| | either enables | actuator | force | |
| | or disables | size | Unsuitable | |
| | movement of | | for pigmented | |
| | an ink pusher | | inks | |
| | that is | | | |
| | controlled | | | |
| | in a bulk | | | |
| | manner. | | | |
| Gears | Gears can be | Low force, | Moving parts | IJ13 |
| | used to | low travel | are required | |
| | increase travel | actuators | Several | |
| | at the expense | can be used | actuator | |
| | of duration. | Can be | cycles are | |
| | Circular gears, | fabricated | required | |
| | rack and | using | More complex | |
| | pinion, | standard | drive | |
| | ratchets, and | surface | electronics | |
| | other gearing | MEMS | Complex | |
| | methods can be | processes | construction | |
| | used. | | Friction, | |
| | | | friction, and | |
| | | | wear are | |
| | | | possible | |
| Buckle | A buckle plate | Very fast | Must stay | S. Hirata et |
| plate | can be used to | movement | within | al, “An Ink- |
| | change a slow | achievable | elastic | jet Head |
| | actuator into a | | limits of the | Using |
| | fast motion. It | | materials for | Diaphragm |
| | can also | | long device | Micro- |
| | convert a high | | life | actuator”, |
| | force, low | | High stresses | Proc. IEEE |
| | travel actuator | | involved | MEMS, Feb. |
| | into a high | | Generally | 1996, pp |
| | travel, medium | | high power | 418-423. |
| | force motion. | | requirement | IJ18, IJ27 |
| Tapered | A tapered | Linearizes | Complex | IJ14 |
| magnetic | magnetic pole | the magnetic | construction | |
| pole | can increase | force/ | | |
| | travel at the | distance | | |
| | expense of | curve | | |
| | force. | | | |
| Lever | A lever and | Matches low | High stress | IJ32, IJ36, |
| | fulcrum is used | travel | around the | IJ37 |
| | to transform a | actuator with | fulcrum | |
| | motion with | higher travel | | |
| | small travel | requirements | | |
| | and high force | Fulcrum area | | |
| | into a motion | has no linear | | |
| | with longer | movement, | | |
| | travel and | and can be | | |
| | lower force. | used for a | | |
| | The lever can | fluid seal | | |
| | also reverse | | | |
| | the direction | | | |
| | of travel. | | | |
| Rotary | The actuator is | High | Complex | IJ28 |
| impeller | connected to | mechanical | construction | |
| | a rotary | advantage | Unsuitable | |
| | impeller. A | The ratio of | for pigmented | |
| | small angular | force to | inks | |
| | deflection of | travel of the | | |
| | the actuator | actuator can | | |
| | results in a | be matched | | |
| | rotation of the | to the | | |
| | impeller vanes, | nozzle | | |
| | which push the | requirements | | |
| | ink against | by varying | | |
| | stationary | the number | | |
| | vanes and out | of impeller | | |
| | of the nozzle. | vanes | | |
| Acoustic | A refractive or | No moving | Large area | 1993 |
| lens | diffractive | parts | required | Hadimioglu |
| | (e.g. zone | | Only relevant | et al, EUP |
| | plate) acoustic | | for acoustic | 550,192 |
| | lens is used to | | ink jets | 1993 Elrod |
| | concentrate | | | et al, EUP |
| | sound waves. | | | 572,220 |
| Sharp | A sharp point | Simple | Difficult to | Tone-jet |
| conductive | is used to | construction | fabricate | |
| point | concentrate an | | using | |
| | electrostatic | | standard VLSI | |
| | field. | | processes for | |
| | | | a surface | |
| | | | ejecting | |
| | | | ink-jet | |
| | | | Only | |
| | | | relevant for | |
| | | | electrostatic | |
| | | | ink jets | |

ACTUATOR MOTION

| | | | | |
|---|---|---|---|---|
| Volume | The volume of | Simple | High energy | Hewlett- |
| expansion | the actuator | construction | is typically | Packard |
| | changes, | in the case | required to | Thermal |
| | pushing the | of thermal | achieve | Ink jet |
| | ink in all | ink jet | volume | Canon |
| | directions. | | expansion. | Bubblejet |
| | | | This leads | |
| | | | to thermal | |
| | | | stress, | |
| | | | cavitation, | |
| | | | and kogation | |
| | | | in thermal | |
| | | | ink jet | |
| | | | implement- | |
| | | | ations | |
| Linear, | The actuator | Efficient | High | IJ01, IJ02, |
| normal | moves in a | coupling to | fabrication | IJ04, IJ07, |
| to chip | direction | ink drops | complexity | IJ11, IJ14 |
| surface | normal to the | ejected | may be | |
| | print head | normal to | required to | |
| | surface. The | the surface | achieve | |
| | nozzle is | | perpendicular | |
| | typically in | | motion | |
| | the line of | | | |
| | movement. | | | |
| Parallel | The actuator | Suitable | Fabrication | IJ12, IJ13, |
| to chip | moves parallel | for planar | complexity | IJ15, IJ33, |
| surface | to the print | fabrication | Friction | IJ34, IJ35, |
| | head surface. | | Stiction | IJ36 |
| | Drop ejection | | | |
| | may still be | | | |
| | normal to the | | | |
| | surface. | | | |
| Membrane | An actuator | The effective | Fabrication | 1982 |
| push | with a high | area of the | complexity | Howkins |
| | force but small | actuator | Actuator size | USP |
| | area is used to | becomes the | Difficulty of | 4,459,601 |
| | push a stiff | membrane | integration | |
| | membrane that | area | in a VLSI | |
| | is in contact | | process | |
| | with the ink. | | | |
| Rotary | The actuator | Rotary levers | Device | IJ05, IJ08, |
| | causes the | may be used | complexity | IJ13, IJ28 |
| | rotation of | to increase | May have | |
| | some element, | travel | friction at a | |
| | such a grill or | Small chip | pivot point | |
| | impeller | area | | |
| | | requirements | | |
| Bend | The actuator | A very small | Requires the | 1970 Kyser |
| | bends when | change in | actuator to | et al USP |
| | energized. This | dimensions | be made from | 3,946,398 |
| | may be due to | can be | at least two | 1973 |
| | differential | converted to | distinct | Stemme USP |
| | thermal | a large | layers, or | 3,747,120 |
| | expansion, | motion. | to have a | IJ03, IJ09, |
| | piezoelectric | | thermal | IJ10, IJ19, |
| | expansion, | | difference | IJ23, IJ24, |
| | magneto- | | across the | IJ25, IJ29, |
| | striction, or | | actuator | IJ30, IJ31, |
| | other form of | | | IJ33, IJ34, |
| | relative | | | IJ35 |
| | dimensional | | | |
| | change. | | | |
| Swivel | The actuator | Allows | Inefficient | IJ06 |
| | swivels around | operation | coupling to | |
| | a central | where the | the ink | |
| | pivot. This | net linear | motion | |
| | motion is | force on the | | |
| | suitable where | paddle is | | |
| | there are | zero | | |
| | opposite forces | Small chip | | |
| | applied to | area | | |
| | opposite sides | requirements | | |
| | of the paddle, | | | |
| | e.g. Lorenz | | | |
| | force. | | | |
| Straighten | The actuator is | Can be used | Requires | IJ26, IJ32 |
| | normally bent, | with shape | careful | |
| | and straightens | memory | balance of | |
| | when | alloys | stresses to | |
| | energized. | where the | ensure that | |
| | | austenic | the quiescent | |
| | | phase is | bend is | |
| | | planar | accurate | |
| Double | The actuator | One actuator | Difficult to | IJ36, IJ37, |
| bend | bends in one | can be used | make the | IJ38 |
| | direction when | to power two | drops ejected | |
| | one element is | nozzles. | by both bend | |
| | energized, and | Reduced | directions | |
| | bends the other | chip size. | identical. | |
| | way when | Not sensitive | A small | |
| | another | to ambient | efficiency | |
| | element is | temperature | loss compared | |
| | energized. | | to equivalent | |
| | | | single bend | |
| | | | actuators. | |
| Shear | Energizing the | Can increase | Not readily | 1985 |
| | actuator causes | the effective | applicable to | Fishbeck |
| | a shear motion | travel of | other | USP |
| | in the actuator | piezoelectric | actuator | 4,584,590 |
| | material. | actuators | mechanisms | |
| Radial | The actuator | Relatively | High force | 1970 Zoltan |
| con- | squeezes an ink | easy to | required | USP |
| striction | reservoir, | fabricate | Inefficient | 3,683,212 |
| | forcing ink | single | Difficult to | |
| | from a | nozzles from | integrate | |
| | constricted | glass tubing | with VLSI | |
| | nozzle. | as | processes | |
| | | macroscopic | | |
| | | structures | | |
| Coil/ | A coiled | Easy to | Difficult to | IJ17, IJ21, |
| uncoil | actuator | fabricate | fabricate for | IJ34, IJ35 |
| | uncoils or | as a planar | non-planar | |
| | coils more | VLSI | devices | |
| | tightly. The | process | Poor out-of- | |
| | motion of the | Small area | plane | |
| | free end of the | required, | stiffness | |
| | actuator ejects | therefore | | |
| | the ink. | low cost | | |
| Bow | The actuator | Can increase | Maximum | IJ16, IJ18, |
| | bows (or | the speed of | travel is | IJ27 |
| | buckles) in the | travel | constrained | |
| | middle when | Mechanic- | High force | |
| | energized. | ally rigid | required | |
| Push- | Two actuators | The structure | Not readily | IJ18 |
| Pull | control a | is pinned at | suitable for | |
| | shutter. One | both ends, so | ink jets | |
| | actuator pulls | has a high | which | |
| | the shutter, | out-of-plane | directly push | |
| | and the other | rigidity | the ink | |
| | pushes it. | | | |
| Curl | A set of | Good fluid | Design | IJ20, IJ42 |
| inwards | actuators curl | flow to | complexity | |
| | inwards to | the region | | |
| | reduce the | behind the | | |
| | volume of ink | actuator | | |
| | that they | increases | | |
| | enclose. | efficiency | | |
| Curl | A set of | Relatively | Relatively | IJ43 |
| outwards | actuators curl | simple | large chip | |
| | outwards, | construction | area | |
| | pressurizing | | | |
| | ink in a | | | |
| | chamber | | | |
| | surrounding the | | | |
| | actuators, and | | | |
| | expelling ink | | | |
| | from a nozzle | | | |
| | in the chamber. | | | |
| Iris | Multiple vanes | High | High | IJ22 |
| | enclose a | efficiency | fabrication | |
| | volume of ink. | Small chip | complexity | |
| | These | area | Not suitable | |
| | simultaneously | | for pigmented | |
| | rotate, | | inks | |
| | reducing the | | | |
| | volume | | | |
| | between | | | |
| | the vanes. | | | |
| Acoustic | The actuator | The actuator | Large area | 1993 |
| vibration | vibrates at a | can be | required for | Hadimioglu |
| | high frequency. | physically | efficient | et al, EUP |
| | | distant from | operation at | 550,192 |
| | | the ink | useful | 1993 Elrod |
| | | | frequencies | et al, EUP |
| | | | Acoustic | 572,220 |
| | | | coupling and | |
| | | | crosstalk | |
| | | | Complex drive | |
| | | | circuitry | |
| | | | Poor control | |
| | | | of drop | |
| | | | volume and | |
| | | | position | |
| None | In various ink | No moving | Various other | Silverbrook, |
| | jet designs the | parts | tradeoffs are | EP 0771 658 |
| | actuator does | | required to | A2 and |
| | not move. | | eliminate | related |
| | | | moving parts | patent |
| | | | | applications |
| | | | | Tone-jet |

NOZZLE REFILL METHOD

| | | | | |
|---|---|---|---|---|
| Surface | This is the | Fabrication | Low speed | Thermal |
| tension | normal way | simplicity | Surface | ink jet |
| | that ink jets are | Operational | tension force | Piezoelectric |
| | refilled. After | simplicity | relatively | ink jet |
| | the actuator is | | small | IJ01-IJ07, |
| | energized, it | | compared to | IJ10-IJ14, |
| | typically | | actuator | IJ16, IJ20, |
| | returns rapidly | | force | IJ22-IJ45 |
| | to its normal | | Long refill | |
| | position. This | | time usually | |
| | rapid return | | dominates | |
| | sucks in air | | the total | |
| | through the | | repetition | |
| | nozzle opening. | | rate | |
| | The ink surface | | | |
| | tension at the | | | |
| | nozzle then | | | |
| | exerts a small | | | |
| | force restoring | | | |
| | the meniscus | | | |
| | to a minimum | | | |
| | area. | | | |
| | This force | | | |
| | refills the | | | |
| | nozzle. | | | |
| Shuttered | Ink to the | High speed | Requires | IJ08, IJ13, |
| oscillating | nozzle chamber | Low actuator | common ink | IJ15, IJ17, |
| ink | is provided at | energy, as | pressure | IJ18, IJ19, |
| pressure | a pressure that | the actuator | oscillator | IJ21 |
| | oscillates at | need only | May not be | |
| | twice the drop | open or close | suitable for | |
| | ejection | the shutter, | pigmented | |
| | frequency. | instead of | inks | |
| | When a drop is | ejecting the | | |
| | to be ejected, | ink drop | | |
| | the shutter is | | | |
| | opened for 3 | | | |
| | half cycles: | | | |
| | drop ejection, | | | |
| | actuator | | | |
| | return, and | | | |
| | refill. The | | | |
| | shutter is then | | | |
| | closed to | | | |
| | prevent the | | | |
| | nozzle chamber | | | |
| | emptying | | | |
| | during the next | | | |
| | negative | | | |
| | pressure cycle. | | | |
| Refiil | After the main | High speed, | Requires two | IJ09 |
| actuator | actuator has | as the nozzle | independent | |
| | ejected a drop | is actively | actuators per | |
| | a second | refilled | nozzle | |
| | (refill) | | | |
| | actuator is | | | |
| | energized. The | | | |
| | refill actuator | | | |
| | pushes ink into | | | |
| | the nozzle | | | |
| | chamber. The | | | |
| | refill actuator | | | |
| | returns slowly, | | | |
| | to prevent its | | | |
| | return from | | | |
| | emptying the | | | |
| | chamber again. | | | |
| Positive | The ink is held | High refill | Surface spill | Silverbrook, |
| ink | a slight | rate, | must be | EP 0771 658 |
| pressure | positive | therefore a | prevented | A2 and |
| | pressure. After | high drop | Highly | related |
| | the ink drop is | repetition | hydrophobic | patent |
| | ejected, the | rate is | print head | applications |
| | nozzle chamber | possible | surfaces are | Alternative |
| | fills quickly | | required | for:, IJ01- |
| | as surface | | | IJ07, IJ10- |
| | tension and ink | | | IJ14, IJ16, |
| | pressure both | | | IJ20, IJ22- |
| | operate to | | | IJ45 |
| | refill the | | | |
| | nozzle. | | | |

METHOD OF RESTRICTIHG BACK-FLOW THROUGH INLET

| | | | | |
|---|---|---|---|---|
| Long | The ink inlet | Design | Restricts | Thermal |
| inlet | channel to the | simplicity | refill rate | ink jet |
| channel | nozzle chamber | Operational | May result in | Piezoelectric |
| | is made long | simplicity | a relatively | ink jet |
| | and relatively | Reduces | large chip | IJ42, IJ43 |
| | narrow, relying | crosstalk | area | |
| | on viscous drag | | Only | |
| | to reduce inlet | | partially | |
| | back-flow. | | effective | |
| Positive | The ink is | Drop | Requires a | Silverbrook, |
| ink | under a | selection and | method (such | EP 0771 658 |
| pressure | positive | separation | as a nozzle | A2 and |
| | pressure, so | forces can | rim or | related |
| | that in the | be reduced | effective | patent |
| | quiescent state | Fast refill | hydro- | applications |
| | some of the ink | time | phobizing, | Possible |
| | drop already | | or both) to | operation |
| | protrudes from | | prevent | of the |
| | the nozzle. | | flooding of | following: |
| | This reduces | | the ejection | IJ01-IJ07, |
| | the pressure in | | surface of | IJ09-IJ12, |
| | the nozzle | | the print | IJ14, IJ16, |
| | chamber which | | head. | IJ20, IJ22, |
| | is required to | | | IJ23-IJ34, |
| | eject a certain | | | IJ36-IJ41, |
| | volume of ink. | | | IJ44 |
| | The reduction | | | |
| | in chamber | | | |
| | pressure | | | |
| | results in a | | | |
| | reduction in | | | |
| | ink pushed out | | | |
| | through the | | | |
| | inlet. | | | |
| Baffle | One or more | The refill | Design | HP Thermal |
| | baffles are | rate is not | complexity | Ink Jet |
| | placed in the | as restricted | May increase | Tektronix |
| | inlet ink flow. | as the long | fabrication | piezoelectric |
| | When the | inlet method. | complexity | ink jet |
| | actuator is | Reduces | (e.g. | |
| | energized, the | crosstalk | Tektronix | |
| | rapid ink | | hot melt | |
| | movement | | Piezoelectric | |
| | creates eddies | | print heads) | |
| | which restrict | | | |
| | the flow | | | |
| | through the | | | |
| | inlet. The | | | |
| | slower refill | | | |
| | process is | | | |
| | unrestricted, | | | |
| | and does not | | | |
| | result in | | | |
| | eddies. | | | |
| Flexible | In this method | Significantly | Not | Canon |
| flap | recently | reduces | applicable to | |
| restricts | disclosed by | back-flow | most ink jet | |
| inlet | Canon, the | for edge- | configurations | |
| | expanding | shooter | Increased | |
| | actuator | thermal ink | fabrication | |
| | (bubble) pushes | jet devices | complexity | |
| | on a flexible | | Inelastic | |
| | flap that | | deformation | |
| | restricts the | | of polymer | |
| | inlet. | | flap results | |
| | | | in creep over | |
| | | | extended use | |
| Inlet | A filter is | Additional | Restricts | IJ04, IJ12, |
| filter | located | advantage | refill rate | IJ24, IJ27, |
| | between the ink | of ink | May result | IJ29, IJ30 |
| | inlet and | filtration | in complex | |
| | the nozzle | Ink filter | construction | |
| | chamber. The | may be | | |
| | filter has a | fabricated | | |
| | multitude of | with no | | |
| | small holes | additional | | |
| | or slots, | process | | |
| | restricting ink | steps | | |
| | flow. The | | | |
| | filter also | | | |
| | removes | | | |
| | particles which | | | |
| | may block the | | | |
| | nozzle. | | | |
| Small | The ink inlet | Design | Restricts | IJ02, IJ37, |
| inlet | channel to the | simplicity | refill rate | IJ44 |
| compared | nozzle chamber | | May result in | |
| to | has a | | a relatively | |
| nozzle | substantially | | large chip | |
| | smaller cross | | area | |
| | section than | | Only | |
| | that of the | | partially | |
| | nozzle | | effective | |
| | resulting in | | | |
| | easier ink | | | |
| | egress out of | | | |
| | the nozzle than | | | |
| | out of the | | | |
| | inlet. | | | |
| Inlet | A secondary | Increases | Requires | IJ09 |
| shutter | actuator | speed of the | separate | |
| | controls the | ink-jet print | refill | |
| | position of a | head | actuator and | |
| | shutter, | operation | drive circuit | |
| | closing off the | | | |
| | ink inlet when | | | |
| | the main | | | |
| | actuator is | | | |
| | energized. | | | |
| The | The method | Eack-flow | Reguires | IJ01, IJ03, |
| inlet is | avoids the | problem is | careful | IJ05, IJ06, |
| located | problem of | eliminated | design to | IJ07, IJ10, |
| behind | inlet back-flow | | minimize the | IJ11, IJ14, |
| the ink- | by arranging | | negative | IJ16, IJ22, |
| pushing | the ink-pushing | | pressure | IJ23, IJ25, |
| surface | surface of the | | behind the | IJ28, IJ31, |
| | actuator | | paddle | IJ32, IJ33, |
| | between the | | | IJ34, IJ35, |
| | inlet and the | | | IJ36, IJ39, |
| | nozzle. | | | IJ40, IJ41 |
| Part of | The actuator | Significant | Small | IJ07, IJ20, |
| the | and a wall of | reductions in | increase in | IJ26, IJ38 |
| actuator | the ink | back-flow | fabrication | |
| moves to | chamber are | can be | complexity | |
| shut off | arranged so | achieved | | |
| the | that the motion | Compact | | |
| inlet | of the actuator | designs | | |
| | closes off the | possible | | |
| | inlet. | | | |
| Nozzle | In some | Ink | None related | Silverbrook, |
| actuator | configurations | back-flow | to ink back- | EP 0771 658 |
| does not | of ink jet, | problem is | flow on | A2 and |
| result | there is no | eliminated | actuation | related |
| in ink | expansion or | | | patent |
| back- | movement of | | | applications |
| flow | an actuator | | | Valve-jet |
| | which may | | | Tone-jet |
| | cause ink back- | | | |
| | flow through | | | |
| | the inlet. | | | |

NOZZLE CLEARING METHOD

| | | | | |
|---|---|---|---|---|
| Normal | All of the | No added | May not be | Most ink jet |
| nozzle | nozzles are | complexity | sufficient to | systems |
| firing | fired | on the | displace | IJ01, IJ02, |
| | periodically, | print head | dried ink | IJ03, IJ04, |
| | before the ink | | | IJ05, IJ06, |
| | has a chance to | | | IJ07, IJ09, |
| | dry. When not | | | IJ10, IJ11, |
| | in use the | | | IJ12, IJ14, |
| | nozzles are | | | IJ16, IJ20, |
| | sealed (capped) | | | IJ22, IJ23, |
| | against air. | | | IJ24, IJ25, |
| | The nozzle | | | IJ26, IJ27, |
| | firing is | | | IJ28, IJ29, |
| | usually | | | IJ30, IJ31, |
| | performed | | | IJ32, IJ33, |
| | during a | | | IJ34, IJ36, |
| | special | | | IJ37, IJ38, |
| | clearing cycle, | | | IJ39, IJ40, |
| | after first | | | IJ41, IJ42, |
| | moving the | | | IJ43, IJ44, |
| | print head to | | | IJ45 |
| | a cleaning | | | |
| | station. | | | |
| Extra | In systems | Can be | Requires | Silverbrook, |
| power to | which heat the | highly | higher drive | EP 0771 658 |
| ink | ink, but do not | effective if | voltage for | A2 and |
| heater | boil it under | the heater is | clearing | related |
| | normal | adjacent to | May require | patent |
| | situations, | the nozzle | larger drive | applications |
| | nozzle clearing | | transistors | |
| | can be | | | |
| | achieved by | | | |
| | overpowering | | | |
| | the heater and | | | |
| | boiling ink at | | | |
| | the nozzle. | | | |
| Rapid | The actuator is | Does not | Effectiveness | May be used |
| succession | fired in rapid | require extra | depends | with: IJ01, |
| of actuator | succession. In | drive | substantially | IJ02, IJ03, |
| pulses | some | circuits on | upon the | IJ04, IJ05, |
| | configurations, | the print | configuration | IJ06, IJ07, |
| | this may cause | head | of the ink | IJ09, IJ10, |
| | heat build-up | Can be | jet nozzle | IJ11, IJ14, |
| | at the nozzle | readily | | IJ16, IJ20, |
| | which boils the | controlled | | IJ22, IJ23, |
| | ink, clearing | and initiated | | IJ24, IJ25, |
| | the nozzle. In | by digital | | IJ27, IJ28, |
| | other | logic | | IJ29, IJ30, |
| | situations, it | | | IJ31, IJ32, |
| | may cause | | | IJ33, IJ34, |
| | sufficient | | | IJ36, IJ37, |
| | vibrations to | | | IJ38, IJ39, |
| | dislodge | | | IJ40, IJ41, |
| | clogged | | | IJ42, IJ43, |
| | nozzles. | | | IJ44, IJ45 |
| Extra | Where an | A simple | Not suitable | May be used |
| power to | actuator is | solution | where there | with: IJ03, |
| ink | not normally | where | is a hard | IJ09, IJ16, |
| pushing | driven to the | applicable | limit to | IJ20, IJ23, |
| actuator | limit of its | | actuator | IJ24, IJ25, |
| | motion, nozzle | | movement | IJ27, IJ29, |
| | clearing may | | | IJ30, IJ31, |
| | be assisted by | | | IJ32, IJ39, |
| | providing an | | | IJ40, IJ41, |
| | enhanced drive | | | IJ42, IJ43, |
| | signal to the | | | IJ44, IJ45 |
| | actuator. | | | |
| Acoustic | An ultrasonic | A high | High | IJ08, IJ13, |
| resonance | wave is applied | nozzle | implementation | IJ15, IJ17, |
| | to the ink | clearing | cost if | IJ18, IJ19, |
| | chamber. This | capability | system does | IJ21 |
| | wave is of an | can be | not already | |
| | appropriate | achieved | include an | |
| | amplitude and | May be | acoustic | |
| | frequency to | implemented | actuator | |
| | cause | at very low | | |
| | sufficient | cost in | | |
| | force at the | systems | | |
| | nozzle to clear | which | | |
| | blockages. This | already | | |
| | is easiest to | include | | |
| | achieve if the | acoustic | | |
| | ultrasonic wave | actuators | | |
| | is at a | | | |
| | resonant | | | |
| | frequency of | | | |
| | the ink cavity. | | | |
| Nozzle | A micro- | Can clear | Accurate | Silverbrook, |
| clearing | fabricated | severely | mechanical | EP 0771 658 |
| plate | plate is pushed | clogged | alignment is | A2 and |
| | against the | nozzles | required | related |
| | nozzles. The | | Moving parts | patent |
| | plate has a | | are required | applications |
| | post for every | | There is risk | |
| | nozzle. A post | | of damage to | |
| | moves through | | the nozzles | |
| | each nozzle, | | Accurate | |
| | displacing | | fabrication | |
| | dried ink. | | is required | |
| Ink | The pressure of | May be | Requires | May be used |
| pressure | the ink is | effective | pressure pump | with all IJ |
| pulse | temporarily | where other | or other | series ink |
| | increased so | methods | pressure | jets |
| | that ink | cannot be | actuator. | |
| | streams from | used | Expensive | |
| | all of the | | Wasteful of | |
| | nozzles. This | | ink | |
| | may be used in | | | |
| | conjunction | | | |
| | with actuator | | | |
| | energizing. | | | |
| Print | A flexible | Effective | Difficult to | Many ink jet |
| head | ‘blade’ is | for planar | use if print | systems |
| wiper | wiped across | print head | head surface | |
| | the print head | surfaces | is non-planar | |
| | surface. The | Low cost | or very | |
| | blade is | | fragile | |
| | usually | | Requires | |
| | fabricated from | | mechanical | |
| | a flexible | | parts | |
| | polymer, e.g. | | Blade can | |
| | rubber or | | wear out in | |
| | synthetic | | high volume | |
| | elastomer. | | print systems | |
| Separate | A separate | Can be | Fabrication | Can be used |
| ink | heater is | effective | complexity | with many IJ |
| boiling | provided at the | where other | | series ink |
| heater | nozzle although | nozzle | | jets |
| | the normal | clearing | | |
| | drop e-ection | methods | | |
| | mechanism | cannot be | | |
| | does not | used | | |
| | require it. | Can be | | |
| | The heaters do | implemented | | |
| | not require | at no | | |
| | individual | additional | | |
| | drive circuits, | cost in some | | |
| | as many | ink jet | | |
| | nozzles can | con- | | |
| | be cleared | figurations | | |
| | simultaneously, | | | |
| | and no imaging | | | |
| | is required. | | | |

NOZZLE PLATE CONSTRUCTION

| | | | | |
|---|---|---|---|---|
| Electro- | A nozzle plate | Fabrication | High | Hewlett |
| formed | is separately | simplicity | temperatures | Packard |
| nickel | fabricated from | | and pressures | Thermal Ink |
| | electroformed | | are required | jet |
| | nickel, and | | to bond | |
| | bonded to the | | nozzle plate | |
| | print head | | Minimum | |
| | chip. | | thickness | |
| | | | constraints | |
| | | | Differential | |
| | | | thermal | |
| | | | expansion | |
| Laser | Individual | No masks | Each hole | Canon |
| ablated | nozzle holes | required | must be | Bubblejet |
| or | are ablated by | Can be quite | individually | 1988 Sercel |
| drilled | an intense UV | fast | formed | et al., SPIE, |
| polymer | laser in a | Some control | Special | Vol. 998 |
| | nozzle piate, | over nozzle | equipment | Excimer |
| | which is | profile is | required | Beam |
| | typically a | possible | Slow where | Applications, |
| | polymer such | Equipment | there are | pp. 76-83 |
| | as polyimide or | required is | many | 1993 |
| | polysulphone | relatively | thousands of | Watanabe |
| | | low cost | nozzles per | et al., USP |
| | | | print head | 5,208,604 |
| | | | May produce | |
| | | | thin burrs at | |
| | | | exit holes | |
| Silicon | A separate | High | Two part | K. Bean, |
| micro- | nozzle plate is | accuracy is | construction | IEEE |
| machined | micromachined | attainable | High cost | Transactions |
| | from single | | Requires | on Electron |
| | crystal | | precision | Devices, |
| | silicon, and | | alignment | Vol. ED-25, |
| | bonded to the | | Nozzles may | No. 10, |
| | print head | | be clogged by | 1978, pp |
| | wafer. | | adhesive | 1185-1195 |
| | | | | Xerox 1990 |
| | | | | Hawkins et |
| | | | | al., USP |
| | | | | 4,899,181 |
| Glass | Fine glass | No | Very small | 1970 Zoltan |
| capillaries | capillaries are | expensive | nozzle sizes | USP |
| | drawn from | equipment | are difficult | 3,683,212 |
| | glass tubing. | required | to form | |
| | This method | Simple to | Not suited | |
| | has been used | make single | for mass | |
| | for making | nozzles | production | |
| | individual | | | |
| | nozzles, but is | | | |
| | difficult to | | | |
| | use for bulk | | | |
| | manufacturing | | | |
| | of print heads | | | |
| | with thousands | | | |
| | of nozzles. | | | |
| Mono- | The nozzle | High | Requires | Silverbrook, |
| lithic, | plate is | accuracy | sacrificial | EP 0771 658 |
| surface | deposited as a | (<1 μm) | layer under | A2 and |
| micro- | layer using | Monolithic | the nozzle | related |
| machined | standard VLSI | Low cost | plate to form | patent |
| using | deposition | Existing | the nozzle | applications |
| VLSI | techniques. | processes | chamber | IJ01, IJ02, |
| litho- | Nozzles are | can be | Surface may | IJ04, IJ11, |
| graphic | etched in the | used | be fragile to | IJ12, IJ17, |
| processes | nozzle plate | | the touch | IJ18, IJ20, |
| | using VLSI | | | IJ22, IJ24, |
| | lithography and | | | IJ27, IJ28, |
| | etching. | | | IJ29, IJ30, |
| | | | | IJ31, IJ32, |
| | | | | IJ33, IJ34, |
| | | | | IJ36, IJ37, |
| | | | | IJ38, IJ39, |
| | | | | IJ40, IJ41, |
| | | | | IJ42, IJ43, |
| | | | | IJ44 |
| Mono- | The nozzle | High | Requires long | IJ03, IJ05, |
| lithic, | plate is a | accuracy | etch times | IJ06, IJ07, |
| etched | buried etch | (<1 μm) | Requires a | IJ08, IJ09, |
| through | stop in the | Monolithic | support wafer | IJ10, IJ13, |
| substrate | wafer. Nozzle | Low cost | | IJ14, IJ15, |
| | chambers are | No | | IJ16, IJ19, |
| | etched in the | differential | | IJ21, IJ23, |
| | front of the | expansion | | IJ25, IJ26 |
| | wafer, and the | | | |
| | wafer is | | | |
| | thinned from | | | |
| | the back side. | | | |
| | Nozzles are | | | |
| | then etched in | | | |
| | the etch stop | | | |
| | layer. | | | |
| No | Various | No nozzles | Difficult to | Ricoh 1995 |
| nozzle | methods have | to become | control drop | Sekiya et al |
| plate | been tried | clogged | position | USP |
| | to eliminate | | accurately | 5,412,413 |
| | the nozzles | | Crosstalk | 1993 |
| | entirely, to | | problems | Hadimioglu |
| | prevent nozzle | | | et al EUP |
| | clogging. | | | 550,192 |
| | These include | | | 1993 Elrod |
| | thermal bubble | | | et al EUP |
| | mechanisms | | | 572,220 |
| | and acoustic | | | |
| | lens | | | |
| | mechanisms | | | |
| Trough | Each drop | Reduced | Drop firing | IJ35 |
| | ejector has a | manu- | direction is | |
| | trough through | facturing | sensitive to | |
| | which a paddle | complexity | wicking. | |
| | moves. There | Monolithlc | | |
| | is no nozzle | | | |
| | plate. | | | |
| Nozzle | The elimination | No nozzles | Difficult to | 1989 Saito |
| slit | of nozzle | to become | control drop | et al USP |
| instead of | holes and | clogged | position | 4,799,068 |
| individual | replacement | | accurately | |
| nozzles | by a slit | | Crosstalk | |
| | encompassing | | problems | |
| | many actuator | | | |
| | positions | | | |
| | reduces nozzle | | | |
| | clogging, but | | | |
| | increases | | | |
| | crosstalk due | | | |
| | to ink surface | | | |
| | waves | | | |

DROP EJECTION DIRECTION

| | | | | |
|---|---|---|---|---|
| Edge | Ink flow is | Simple | Nozzles | Canon |
| (‘edge | along the | construction | limited to | Bubblejet |
| shooter’) | surface of the | No silicon | edge | 1979 Endo et |
| | chip, and ink | etching | High | al GB patent |
| | drops are | required | resolution is | 2,007,162 |
| | erected from | Good heat | difficult | Xerox |
| | the chip edge. | sinking via | Fast color | heater-in-pit |
| | | substrate | printing | 1990 |
| | | Mechanic- | requires one | Hawkins |
| | | ally | print head | et al USP |
| | | strong | per color | 4,899,181 |
| | | Ease of chip | | Tone-jet |
| | | handing | | |
| Surface | Ink flow is | No bulk | Maximum ink | Hewlett- |
| (‘roof | along the | silicon | flow is | Packard TIJ |
| shooter’) | surface of the | etching | severely | 1982 Vaught |
| | chip, and ink | required | restricted | et al USP |
| | drops are | Silicon can | | 4,490,728 |
| | ejected from | make an | | IJ02, IJ11, |
| | the chip | effective | | IJ12, IJ20, |
| | surface, normal | heat sink | | IJ22 |
| | to the plane of | Mechanical | | |
| | the chip. | strength | | |
| Through | Ink flow is | Hiqh ink | Requires bulk | Silverbrook, |
| chip, | through the | flow | silicon | EP 0771 658 |
| forward | chip, and ink | Suitable for | etching | A2 and |
| (‘up | drops are | pagewidth | | related |
| shooter’) | ejected from | print heads | | patent |
| | the front | High nozzle | | applications |
| | surface of the | packing | | IJ04, IJ17, |
| | chip. | density | | IJ18, IJ24, |
| | | therefore | | IJ27-IJ45 |
| | | low manu- | | |
| | | facturing | | |
| | | cost | | |
| Through | Ink flow is | High ink | Requires | IJ01, IJ03, |
| chip, | through the | flow | wafer | IJ05, IJ06, |
| reverse | chip, and ink | Suitable for | thinning | IJ07, IJ08, |
| (‘down | drops are | pagewidth | Requires | IJ09, IJ10, |
| shooter’) | ejected from | print heads | special | IJ13, IJ14, |
| | the rear | High nozzle | handling | IJ15, IJ16, |
| | surface of the | packing | during | IJ19, IJ21, |
| | chip. | density | manufacture | IJ23, IJ25, |
| | | therefore low | | IJ26 |
| | | manu- | | |
| | | facturing | | |
| | | cost | | |
| Through | Ink flow is | Suitable for | Pagewidth | Epson Stylus |
| actuator | through the | piezoelectric | print heads | Tektronix |
| | actuator, which | print heads | require | hot melt |
| | is not | | several | piezoelectric |
| | fabricated as | | thousand | ink jets |
| | part of the | | connections | |
| | same substrate | | to drive | |
| | as the drive | | circuits | |
| | transistors. | | Cannot be | |
| | | | manufactured | |
| | | | in standard | |
| | | | CMOS fabs | |
| | | | Complex | |
| | | | assembly | |
| | | | required | |

INK TYPE

| | | | | |
|---|---|---|---|---|
| Aqueous, | Water based | Environ- | Slow drying | Most |
| dye | ink which | mentally | Corrosive | existing |
| | typically: | friendly | Bleeds on | ink jets |
| | contains water, | No odor | paper | All IJ series |
| | dye, surfactant, | | May | ink jets |
| | humectant, and | | strikethrough | Silverbrook, |
| | biocide. | | Cockles paper | EP 0771 658 |
| | Modern ink | | | A2 and |
| | dyes have high | | | related |
| | water-fastness, | | | patent |
| | light fastness | | | applications |
| Aqueous, | Water based | Environ- | Slow drying | IJ02, IJ04, |
| pigment | ink which | mentally | Corrosive | IJ21, IJ26, |
| | typically | friendly | Pigment may | IJ27, IJ30 |
| | contains: water, | No odor | clog nozzles | Silverbrook, |
| | pigment, | Reduced | Pigment may | EP 0771 658 |
| | surfactant, | bleed | clog actuator | A2 and |
| | humectant, and | Reduced | mechanisms | related |
| | biocide. | wicking | Cockles paper | patent |
| | Pigments have | Reduced | | applications |
| | an advantage in | strike- | | Piezoelectric |
| | reduced bleed, | through | | ink-jets |
| | wicking and | | | Thermal ink |
| | strikethrough. | | | jets (with |
| | | | | significant |
| | | | | restrictions) |
| Methyl | MEK is a | Very fast | Odorous | All IJ series |
| Ethyl | highly volatile | drying | Flammable | ink jets |
| Ketone | solvent used | Prints on | | |
| (MEK) | for industrial | various | | |
| | printing on | substrates | | |
| | difficult | such as | | |
| | surfaces such | metals and | | |
| | as aluminum | plastics | | |
| | cans. | | | |
| Alcohol | Alcohol based | Fast drying | Slight odor | All IJ series |
| (ethanol | inks can be | Operates at | Flammable | ink jets |
| 2- | used where the | sub-freezing | | |
| butanol, | printer must | temperatures | | |
| and | operate at | Reduced | | |
| others) | temperatures | paper | | |
| | below the | cockle | | |
| | freezing point | Low cost | | |
| | of water. An | | | |
| | example of this | | | |
| | is in-camera | | | |
| | consumer | | | |
| | photographic | | | |
| | printing. | | | |
| Phase | The ink is | No drying | High | Tektronix |
| change | solid at room | time—ink | viscosity | hot melt |
| (hot | temperature, | instantly | Printed ink | piezoelectric |
| melt) | and is melted | freezes on | typically has | ink jets |
| | in the print | the print | a ‘waxy’ feel | 1989 Nowak |
| | head before | medium | Printed pages | USP |
| | jetting. Hot | Almost | may ‘block’ | 4,820,346 |
| | melt inks are | any print | Ink | All IJ series |
| | usually wax | medium can | temperature | ink jets |
| | based, with a | be used | may be above | |
| | melting point | No paper | the curie | |
| | around 80° C. | cockle | point of | |
| | After jetting | occurs | permanent | |
| | the ink freezes | No wicking | magnets | |
| | almost | occurs | Ink heaters | |
| | instantly upon | No bleed | consume power | |
| | contacting the | occurs | Long warm-up | |
| | print medium | No | time | |
| | or a transfer | strikethrough | | |
| | roller. | occurs | | |
| Oil | Oil based inks | High | High | All IJ series |
| | are extensively | solubility | viscosity: | ink jets |
| | used in offset | medium for | this is a | |
| | printing. | some dyes | significant | |
| | They have | Does not | limitation | |
| | advantages | cockle paper | for use in | |
| | in improved | Does not | ink jets, | |
| | characteristics | wick | which usually | |
| | on paper | through | require a low | |
| | (especially no | paper | viscosity. | |
| | wicking or | | Some short | |
| | cockle). Oil | | chain and | |
| | soluble dies | | multi- | |
| | and pigments | | branched oils | |
| | are required. | | have a | |
| | | | sufficiently | |
| | | | low | |
| | | | viscosity. | |
| | | | Slow drying | |
| Micro- | A micro- | Stops ink | Viscosity | All IJ series |
| emulsion | emulsion is a | bleed | higher than | ink jets |
| | stable, self | High dye | water | |
| | forming | solubility | Cost is | |
| | emulsion of oil, | Water, oil, | slightly | |
| | water, and | and | higher than | |
| | surfactant. The | amphiphilic | water based | |
| | characteristic | soluble dies | ink | |
| | drop size is | can be used | High | |
| | less than 100 | Can stabilize | surfactant | |
| | nm, and is | pigment | concentration | |
| | determined by | suspensions | required | |
| | the preferred | | (around 5%) | |
| | curvature of | | | |
| | the surfactant. | | | |

We claim:

1. In a portable camera system a method of color correcting a sensed image, the method including the steps of:
obtaining a first image;
determining color characteristics of said first image;
obtaining a second image in rapid succession to said first image; and
applying color correction to said second image based on the determined color characteristics of said first image to produce a modified second image.

2. The method as claimed in claim 1 wherein said second image is sensed within 1 second of said first image.

3. The method as claimed in claim 1 wherein the step of determining color characteristics includes examining the intensity characteristics of said first image.

4. The method as claimed in claim 1 wherein the step of determining color characteristics includes determining a maximum and minimum intensity of said first image and utilizing said intensities to rescale the intensities of said second image.

5. The method as claimed on claim 1 wherein an image sensor device is utilized to obtain the first image and the second image.

6. The method as claimed in claim 1 wherein a processor is used to determine the color characteristics of the first image and to apply color correction to produce the modified second image.

7. The method as claimed in claim 1 including printing the modified second image.

8. The method as claimed in claim 7 wherein the camera includes a printing system and printing the modified second image includes printing the modified second image with the printing system.

9. The method as claimed in claim 1 includes determining intensity characteristics of said first image.

10. The method as claimed in claim 1 wherein modifying the second image includes modifying the intensity characteristics.
